(19) United States
(12) Patent Application Publication
(10) Pub. No.: US 2025/0289924 A1
(43) Pub. Date: Sep. 18, 2025

(54) SILANE-CONTAINING COMPOUND AND MODIFIED HYDROGENATED PETROLEUM RESIN

(71) Applicant: IDEMITSU KOSAN CO.,LTD., Chiyoda-ku (JP)

(72) Inventors: Masami KANAMARU, Chiba-shi (JP); Yutaka MINAMI, Chiba-shi (JP); Takafumi AKIMOTO, Yotsukaido-shi (JP)

(73) Assignee: IDEMITSU KOSAN CO.,LTD., Chiyoda-ku (JP)

(21) Appl. No.: 19/220,421

(22) Filed: May 28, 2025

Related U.S. Application Data
(62) Division of application No. 17/760,215, filed on Aug. 5, 2022.

(30) Foreign Application Priority Data
Feb. 10, 2020 (JP) 2020-020757
Nov. 17, 2020 (JP) 2020-191071

(51) Int. Cl. C08G 61/08; C08L 9/06; C08L 95/00; C09J 109/06; C09J 123/12; C09J 195/00

(52) U.S. Cl. CPC C08G 61/08; C08L 9/06; C08L 95/00; C09J 109/06; C09J 123/12; C09J 195/00

(57) ABSTRACT

A silane-containing compound having a cyclic structure in a molecular structure; a modified hydrogenated petroleum resin in which a bromine value, a silicon element content, a weight average molecular weight, and a molecular weight distribution are specific values; a modified hydrogenated petroleum resin obtained by subjecting the modified hydrogenated petroleum resin to a condensation reaction; an adhesive composition including the modified hydrogenated petroleum resin; an asphalt composition containing the silane-containing compound or the modified hydrogenated petroleum resin.

### TECHNICAL FIELD

The present invention relates to a silane-containing compound and a modified hydrogenated petroleum resin.

### BACKGROUND ART

Silane compounds are used as materials that enhance the affinity between inorganic substances and organic substances. For example, trialkoxyaminoalkylsilane and the like are widely used as silane coupling agents in a dispersion improver for dispersing an inorganic substance in an organic substance such as a resin, or an adhesiveness improver for adhering an organic substance to an inorganic surface.

In recent years, the main cause of damage to asphalt pavement has been the phenomenon of asphalt peeling, in which rainwater or groundwater permeates between the asphalt and an aggregate and the asphalt coated on the surface of the aggregate peels off. When such an asphalt peeling phenomenon occurs, the function of adhering the aggregates to each other is deteriorated, and there is a possibility that damage such as cracks and potholes is likely to occur.

In response to the occurrence of such asphalt peeling phenomenon, methods for suppressing peeling of asphalt have been studied by mixing asphalt with, as an anti-peeling agent, resin acids such as dimer acid and rosin, and fatty acids, for example, saturated fatty acids such as stearic acid, palmitic acid and myristic acid, and unsaturated fatty acids such as oleic acid, linoleic acid and lysylenonic acid (PTLs 1 and 2).

Further, the technique disclosed in PTL 3 is an asphalt composition containing an asphalt base oil and a silane-containing coupling agent. However, the silane-containing coupling agent disclosed in PTL 3 has a problem that the efficiency of functional expression is low because it is flexible and contains a plurality of silane atoms in one molecule. In addition, the amount of the silane-containing coupling agent contained in the asphalt composition is large, which increases the cost.

On the other hand, petroleum resin is a highly useful resin as a hot-melt type adhesive or a tackifier of adhesive tapes. Then, the petroleum resin is usually produced by polymerizing in a solvent, as raw materials, unsaturated compounds having 5 to 9 carbon atoms obtained as by-products during the production of olefins by thermal decomposition of naphtha and the like, and then separating and removing the solvent and a low molecular weight polymer from the obtained polymerization product.

Modified petroleum resins are being developed to provide further effects to petroleum resins.

For example, with a purpose of obtaining a curable petroleum resin, PTL 4 discloses a curable petroleum resin containing a repeating unit of a ring structure having a specific ethylenically unsaturated group, copolymerized with silanes, and having specific ranges of proton content and weight average molecular weight of the silanes.

Further, PTL 5 discloses, as a hot-melt adhesive, a reactive hot-melt adhesive composition for wrapping an interior building material, which includes a graft modified product obtained by reacting an amorphous poly-α-olefin polymer having a specific softening point with an alkoxysilane compound, and an olefin resin, with a purpose of improving coating property, wrapping property, initial heat resistance, adhesiveness, etc.

### CITATION LIST

### Patent Literature

PTL 1: JP 2016-121320 A
PTL 2: JP 2015-143340 A
PTL 3: JP 6475390 A
PTL 4: JP 2017-523288 A
PTL 5: JP 2004-176028 A

### SUMMARY OF INVENTION

### Technical Problem

Although the anti-peeling agents such as resin acid and fatty acid are expensive for the asphalt peeling phenomenon as described above, even if they are added in excess of a certain amount, a sufficient anti-peeling effect cannot be obtained especially for acid rocks such as granite. Therefore, a technique for suppressing asphalt peeling is required for these rocks as well.

Therefore, a first object of the present invention is to provide a technique of suppressing peeling of asphalt and improving water resistance.

On the other hand, a hot-melt adhesive (hereinafter, in the present specification, both a reactive hot-melt adhesive and a non-reactive adhesive are included) melts a resin by heat and solidifies the resin to bond objects to each other. Therefore, at high temperatures, the bonded portion is likely to be deformed or peeled off, and high heat resistance is required especially for automobile interiors and woodworking applications around kitchens.

Since hot-melt adhesives and pressure-sensitive adhesives do not require a solvent, they have little impact on the environment and health. However, the odor derived from volatile organic compounds contained in low molecular weight substances such as the raw materials aromatic compound elastomers and tackifiers has become a problem, and in addition to the above-mentioned automobile interior and woodworking applications, it is required to further reduce the odor for daily necessities such as paper diapers. Similarly, there is a problem that the adhesive is colored and the appearance is deteriorated, and colorlessness is also required.

In the petroleum resins and the hot-melt adhesive composition of PTLs 4 and 5, although curability and initial heat resistance have been improved, further heat resistance, faint odor, and high colorlessness are required.

Therefore, a second object of the present invention is to provide a modified hydrogenated petroleum resin having excellent heat resistance, faint odor and excellent colorlessness.

Further, an adhesive composition such as a hot-melt adhesive is required to have both good coatability and high adhesive strength.

Therefore, a third object of the present invention is to provide a modified hydrogenated petroleum resin and an adhesive composition capable of achieving both good coatability and high adhesive strength.

### Solution to Problem

As a result of intensive studies, the present inventors have found that the first object can be solved by setting the bromine value, which is the degree of unsaturation of petroleum resin, to a specific value, and setting the silane modification amount and the molecular weight within a specific range.

That is, the present invention according to a first aspect (hereinafter, also referred to as “first invention”) relates to the following <1> to <13>.
<1> A silane-containing compound having a cyclic structure in a molecular structure.
<2> The silane-containing compound according to <1>, wherein the cyclic structure is a structure in which three or more of at least one ring structure selected from an aromatic ring and a 5- or more membered alicyclic ring are linked.
<3> The silane-containing compound according to <1> or <2>, wherein the cyclic structure is a structure represented by any of the following general formulae (1) to (4):

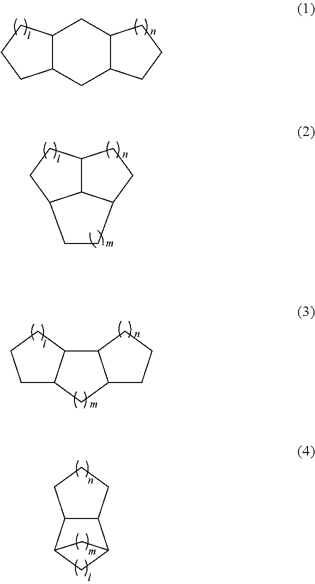

wherein
l, m and n each are independently 1 or 2, and a straight line indicates a single bond or a double bond, provided that the double bond is not continuous.
<4> The silane-containing compound according to any one of <1> to <3>, wherein the cyclic structure is a structure represented by any of the following formulae (5) to (7).

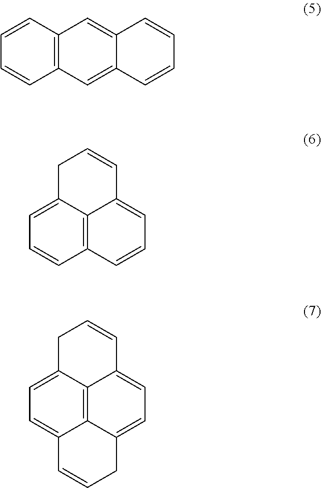

<5> The silane-containing compound according to any one of <1> to <3>, wherein the cyclic structure is a structure represented by any of the following formulae (8) to (11).

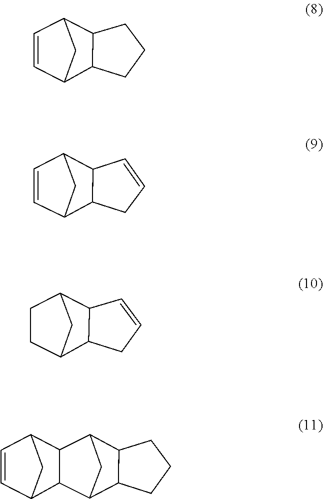

<6> The silane-containing compound according to any one of <1> to <5>, wherein an integral ratio of aromatic hydrogen [integral value of peak in 6.5 to 7.5 ppm region/(sum of integral value of peak in 0 to 3.0 ppm region and integral value of peak in 6.5 to 7.5 ppm region)] in ¹H-NMR measurement is 70% or less.
<7> The silane-containing compound according to any one of <1> to <6>, having a softening point of 90° C. or higher.
<8> The silane-containing compound according to any one of <1> to <6>, having a viscosity at 40° C. of 1 to 1,000 mPa·s.
<9> The silane-containing compound according to any one of <1> to <7>, having a glass transition temperature of 30° C. or higher.
<10> The silane-containing compound according to any one of <1> to <9>, wherein a ratio of absorbance (ASiO) derived from a silicon-oxygen bond and absorbance (ACH) derived from a carbon-hydrogen bond in IR measurement satisfies the following relational expression.

$$0.01 < ASiO / ACH < 0.37$$

<11> The silane-containing compound according to any one of <1> to <10>, wherein an integral ratio of tertiary carbon [integral value of peak in 35 to 64 ppm region/integral value of peak in 10 to 64 ppm region] in ¹³C-NMR measurement is 2 to 80%.
<12> An asphalt composition containing the silane-containing compound according to any one of <1> to <11> and straight asphalt, wherein the straight asphalt has a content of 70.00 to 99.99% by mass.
<13> An asphalt mixture containing the asphalt composition according to <12> and an aggregate, wherein the aggregate has a content of 80 to 99% by mass.

As a result of intensive studies, the present inventors have found that the first object and the second object can be solved by setting the bromine value, which is the degree of unsaturation of petroleum resin, to a specific value, and setting the silane modification amount and the molecular weight within a specific range.

That is, the present invention according to a second aspect (hereinafter, also referred to as “second invention”) relates to the following <14> to <23>.
<14> A modified hydrogenated petroleum resin satisfying the following (A1) to (A4):
   (A1) a bromine value of 0.1 to 10.0
   (A2) containing 0.1 to 10% by mass of silicon element in terms of silicon atom
   (A3) a weight average molecular weight of 500 to 5,000
   (A4) a molecular weight distribution (Mw/Mn) of 1.1 to 3.5.
<15> The modified hydrogenated petroleum resin according to <14>, wherein an integral ratio of aromatic hydrogen [integral value of peak in 6.5 to 7.5 ppm region/(sum of integral value of peak in 0 to 3.0 ppm region and integral value of peak in 6.5 to 7.5 ppm region)] in ¹H-NMR measurement is 0 to 15%.
<16> The modified hydrogenated petroleum resin according to <14> or <15>, having a softening point of 60 to 150° C.
<17> The modified hydrogenated petroleum resin according to any one of <14> to <16>, having a volatile component content of 1.0% by mass or less when heated at 150° C. for 20 minutes.
<18> The modified hydrogenated petroleum resin according to any one of <14> to <17>, wherein an alkoxysilyl group is bonded to a main chain of a hydrogenated petroleum resin via a bonding portion.
<19> A method of producing a modified hydrogenated petroleum resin, wherein a hydrogenated petroleum resin, and a compound containing a carbon-carbon double bond and an alkoxysilyl group are reacted in the presence of a compound that generates radicals.
<20> A hot-melt adhesive containing 1 to 70% by mass of the modified hydrogenated petroleum resin according to any one of <14> to <18>.
<21> A pressure-sensitive adhesive containing 1 to 70% by mass of the modified hydrogenated petroleum resin according to any one of <14> to <18>.
<22> An asphalt composition containing the modified hydrogenated petroleum resin according to any one of <14> to <18> and straight asphalt, wherein the straight asphalt has a content of 70.00 to 99.99% by mass.
<23> An asphalt mixture containing the asphalt composition according to <22> and an aggregate, wherein the aggregate has a content of 80 to 99% by mass.

Further, as a result of intensive studies, the present inventors have found that the first object and the third object can be solved by subjecting the above-mentioned modified hydrogenated petroleum resin to a condensation reaction to satisfy a specific viscosity range.

That is, the present invention according to a third aspect (hereinafter, also referred to as “third invention”) relates to the following <24> to <34>.
<24> A modified hydrogenated petroleum resin, which is a modified hydrogenated petroleum resin (B) obtained by subjecting a modified hydrogenated petroleum resin (A) satisfying the following (A1) to (A4) to a condensation reaction, wherein the modified hydrogenated petroleum resin (B) satisfies the following (B1) to (B3):
   (A1) a bromine value of 0.1 to 10.0
   (A2) containing 0.1 to 10% by mass of silicon element in terms of silicon atom
   (A3) a weight average molecular weight of 500 to 5,000
   (A4) a molecular weight distribution (Mw/Mn) of 1.1 to 3.5
   (B1) a viscosity V0.1 measured using a rheometer at 190° C. with an angular velocity ω=0.1 rad/s of 1,000 to 50,000 mPa·s
   (B2) a viscosity V100 measured using a rheometer at 190° C. with an angular velocity ω=100 rad/s of 100 to 1,000 mPa·s
   (B3) a ratio of the viscosity V0.1 to the viscosity V100 [V0.1/V100] of 10 or more.
<25> The modified hydrogenated petroleum resin according to <24>, wherein an integral ratio of aromatic hydrogen [integral value of peak in 6.5 to 7.5 ppm region/(sum of integral value of peak in 0 to 3.0 ppm region and integral value of peak in 6.5 to 7.5 ppm region)] in ¹H-NMR measurement of the modified hydrogenated petroleum resin (A) is 0 to 15%.
<26> The modified hydrogenated petroleum resin according to <24> or <25>, wherein the modified hydrogenated petroleum resin (A) has a softening point of 60 to 150° C.
<27> The modified hydrogenated petroleum resin according to any one of <24> to <26>, wherein the modified hydrogenated petroleum resin (A) has a volatile component content of 1.0% by mass or less when heated at 150° C. for 20 minutes.
<28> The modified hydrogenated petroleum resin according to any one of <24> to <27>, which is a modified hydrogenated petroleum resin in which the modified hydrogenated petroleum resin (A) has an alkoxysilyl group that is bonded to a main chain of a hydrogenated petroleum resin via a bonding portion.
<29> A method of producing a modified hydrogenated petroleum resin, which is a method of producing a modified hydrogenated petroleum resin (B) satisfying the following (B1) to (B3), wherein the method includes the following step (a):
   (B1) a viscosity V0.1 measured using a rheometer at 190° C. with an angular velocity ω=0.1 rad/s of 1,000 to 50,000 mPa·s
   (B2) a viscosity V100 measured using a rheometer at 190° C. with an angular velocity ω=100 rad/s of 100 to 1,000 mPa·s
   (B3) a ratio of the viscosity V0.1 to the viscosity V100 [V0.1/V100] of 10 or more
   step (a): a step of subjecting a modified hydrogenated petroleum resin satisfying the following (A1) to (A4) to a condensation reaction:
   (A1) a bromine value of 0.1 to 10.0
   (A2) containing 0.1 to 10% by mass of silicon element in terms of silicon atom
   (A3) a weight average molecular weight of 500 to 5,000
   (A4) a molecular weight distribution (Mw/Mn) of 1.1 to 3.5.
<30> An adhesive composition, which is an adhesive composition (C) including the modified hydrogenated petroleum resin (B) according to any one of <24> to <28> or the modified hydrogenated petroleum resin (B) obtained by the production method according to <29>, wherein the adhesive composition satisfies the following (C1) to (C3):
   (C1) a viscosity V0.1 measured using a rheometer at 190° C. with an angular velocity ω=0.1 rad/s of 20,000 to 800,000 mPa·s
   (C2) a viscosity V100 measured using a rheometer at 190° C. with an angular velocity ω=100 rad/s of 1,000 to 5,000 mPa·s
   (C3) a ratio of the viscosity V0.1 to the viscosity V100 [V0.1/V100] of 10 or more.
<31> The adhesive composition according to <30>, containing 1 to 70% by mass of the modified hydrogenated petroleum resin (B) according to any one of <24> to <28> or the modified hydrogenated petroleum resin (B) obtained by the production method according to <29>.
<32> The adhesive composition according to <30> or <31>, further containing 10 to 90% by mass of a base polymer.
<33> An asphalt composition containing the modified hydrogenated petroleum resin (B) according to any one of <24> to <28> and straight asphalt, wherein the straight asphalt has a content of 70.00 to 99.99% by mass.
<34> An asphalt mixture containing the asphalt composition according to <33> and an aggregate, wherein the aggregate has a content of 80 to 99% by mass.

### Advantageous Effects of Invention

The silane-containing compound according to the first invention suppresses asphalt peeling and improves water resistance.

The modified hydrogenated petroleum resin according to the second invention has excellent heat resistance, faint odor, and excellent colorlessness. In addition, it suppresses asphalt peeling and improves water resistance.

Further, the third invention can provide a modified hydrogenated petroleum resin and an adhesive composition capable of achieving both good coatability and high adhesive strength. In addition, it suppresses asphalt peeling and improves water resistance.

### DESCRIPTION OF EMBODIMENTS

### [First Invention]

Hereinafter, the silane-containing compound, the asphalt composition, and the asphalt mixture according to one aspect of the first invention will be described in order.

### [Silane-Containing Compound]

The silane-containing compound according to one aspect of the first invention has a cyclic structure in the molecular structure.

The cyclic structure is preferably a structure in which three or more of at least one ring structure selected from an aromatic ring and a 5-membered or more membered alicyclic ring are linked, more preferably a structure in which three or more of at least one ring structure selected from a 4- to 6-membered aromatic ring and a 5- or 6-membered alicyclic ring are linked, and further more preferably a structure in which three or more and five or less of at least one ring structure selected from a 5- or 6-membered aromatic ring and a 5- or 6-membered alicyclic ring are linked.

A suitable cyclic structure will be specifically described below.

The cyclic structure is preferably a structure represented by any of the following general formulae (1) to (4).

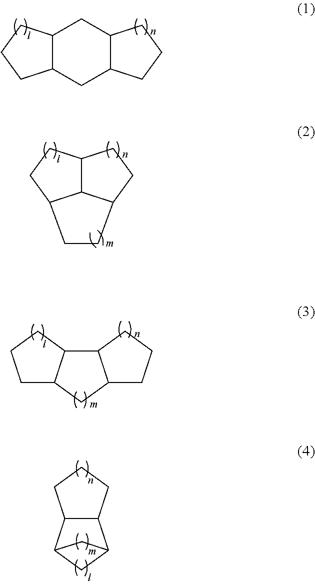

In each formula, l, m and n each are independently 1 or 2, and a straight line indicates a single bond or a double bond, provided that the double bond is not continuous.

The vertices and intersections of the polygons in each of the above formulae indicate carbon atoms.

In each of the above formulae, 1, m and n each are independently 1 or 2. For example, in the formula (1), it indicates a cyclic structure of any one of a 5-membered ring-6-membered ring-5-membered ring, a 5-membered ring-6-membered ring-6-membered ring, a 6-membered ring-6-membered ring-5-membered ring, and a 6-membered ring-6-membered ring-6-membered ring.

In each of the above formulae, the straight line indicates a single bond or a double bond. However, the double bond is not continuous, and there are no two or more double bonds in one carbon atom.

Of the structures represented by any of the general formulae (1) to (4), more preferable structures are shown below.

The cyclic structure is more preferably a structure represented by any of the following formulae (5) to (7).

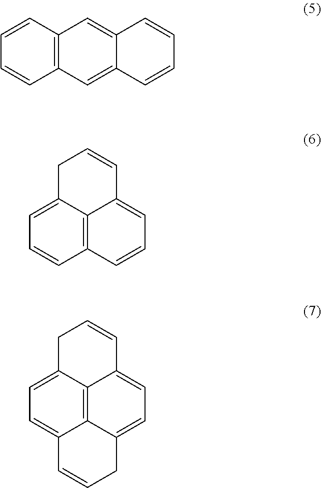

Further, the cyclic structure is more preferably a structure represented by any of the following formulae (8) to (11).

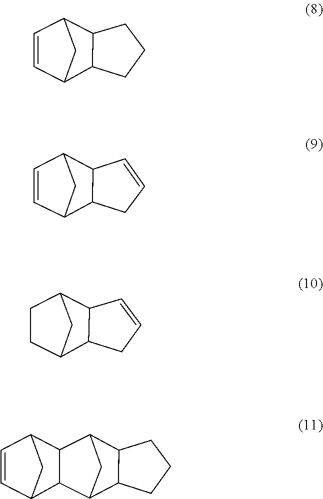

Of the structures represented by any of the general formulae (5) to (11), the structure represented by formulae (5) is further more preferable.

In the silane-containing compound according to one aspect of the first invention, an integral ratio of aromatic hydrogen [integral value of peak in 6.5 to 7.5 ppm region/(sum of integral value of peak in 0 to 3.0 ppm region and integral value of peak in 6.5 to 7.5 ppm region)] in ¹H-NMR measurement is preferably 70% or less, more preferably 40% or less, and further more preferably 20% or less.

The integral ratio of aromatic hydrogen in the ¹H-NMR measurement is a value indicating the ratio of aromatic moiety in the silane-containing compound. It is preferable that the integral ratio of aromatic hydrogen in ¹H-NMR measurement is in the above range because the compatibility with asphalt is high.

Asphalt contains paraffin, naphthen, and aromatic components, and generally, the aroma component (aromatic component) is lower. Therefore, in the present technique, it is expected that the lower the aroma component, the higher the compatibility with asphalt.

The integral ratio of aromatic hydrogen in ¹H-NMR measurement can be specifically measured by a method described in Examples.

When the silane-containing compound according to one aspect of the first invention is a solid, the softening point thereof is preferably 90° C. or higher, more preferably 95° C. or higher.

The softening point can be measured by a ring-and-ball method, and can be specifically measured by a method described in Examples.

It is preferable that the softening point is within the above range because the adhesive strength at the interface between the aggregate and the asphalt is improved.

When the silane-containing compound according to one aspect of the first invention is a liquid, the viscosity thereof at 40° C. is preferably 1 to 1,000 mPa·s, and more preferably 1 to 100 mPa·s.

It is preferable that the viscosity is in the above range because the compatibility with asphalt is improved, and the reactivity with the aggregate surface is increased, resulting in an improved water resistance.

When the silane-containing compound according to one aspect of the first invention is a thermoplastic resin, the glass transition temperature thereof is preferably 30° C. or higher, more preferably 40° C. or higher.

It is preferable that the glass transition temperature is in the above range because the interfacial strength between the aggregate and the asphalt increases.

In the silane-containing compound, a ratio of absorbance (ASiO) derived from a silicon-oxygen bond and absorbance (ACH) derived from a carbon-hydrogen bond in IR measurement preferably satisfies the following relational expression.

0.01<ASiO/ACH<0.37

The ratio (ASiO/ACH) is preferably larger than 0.01, more preferably larger than 0.03. Further, it is preferably smaller than 0.37 and more preferably smaller than 0.20.

By satisfying the above relational expression, the amount of silane atom introduced becomes an appropriate amount, and the material of the present technique reacts with the aggregate surface in just amount, which is preferable.

In the silane-containing compound according to one aspect of the first invention, an integral ratio of tertiary carbon [integral value of peak in 35 to 64 ppm region/integral value of peak in 10 to 64 ppm region] in ¹³C-NMR measurement is preferably 2 to 80%, more preferably 2 to 70%, further more preferably 10 to 70%, and still further more preferably 40 to 70%.

The integral ratio of tertiary carbon is a value indicating the ratio of tertiary carbon in the silane-containing compound. It is preferable that the integral ratio of tertiary carbon is within the above range because the silane compound has a rigid structure and the interfacial strength between the aggregate and the asphalt is improved.

The integral ratio of tertiary carbon can be specifically measured by a method described in Examples.

The silane-containing compound according to one aspect of the first invention preferably has a cyclic structure in the molecular structure as described above and has the properties described above. However, when used as a raw material for an asphalt composition, it is preferable to have the following characteristics.

Asphalt is a composition having a range of molecular weights of alicyclic structure, paraffin structure, and polycyclic aromatic structure. Further, when the adhesive strength between the asphalt composition and the aggregate is improved, particularly not only the water resistance of the asphalt road but also the durability against the load is improved. Therefore, it is very important to improve the adhesiveness between the asphalt composition and the aggregate. In order to enhance the adhesiveness, it is considered that an additive having a silane-containing structure that reacts with and bonds with a hydroxy group on the surface of the aggregate and being compatible with asphalt is preferable.

Furthermore, when there are hard materials, the asphalt at the interface of the aggregate becomes hard. As a result, even if a load is applied to the interface, the force can be received by the entire interface and it is presumed that the adhesive strength between the asphalt and the aggregate is improved. It is also preferable to have both polycyclic aromatics and alicyclic structures so as to be compatible with asphalt.

Therefore, the silane-containing compound according to one aspect of the first invention is preferably a compound having a silane-containing group and further having a rigid polycyclic aromatic and an alicyclic structure. Specifically, examples thereof include a partially hydrogenated petroleum resin having a silane-containing group, a hydrogenated petroleum resin having a silane-containing group, an unhydrogenated petroleum resin having a silane-containing group, a cycloolefin copolymer having a silane-containing group, a hydrogenated polymer of SBS having a silane-containing group, and asphalt having a silane-containing group.

### [Method of Producing Silane Compound]

The method of producing a silane compound according to one aspect of the first invention is not particularly limited; however, a method of introducing silane into an organic compound having a cyclic structure in the molecular structure is preferable.

As a method of producing a silane compound according to one aspect of the first invention, the following method is preferable from the viewpoint of efficiently introducing silane.

The method of producing the silane compound is preferably (A) a method of reacting an organic compound having a cyclic structure with a compound having a carbon-carbon double bond and an alkoxysilyl group in the presence of a compound that generates radicals, or (B) a method of reacting an organic compound having a carbon-carbon double bond and a cyclic structure with a compound having an alkoxysilyl group and a silicon-hydrogen bond in the presence of a metal catalyst or a compound that generates radicals.

As a method of introducing an alkoxysilyl group into a compound containing an unsaturated bond, it is preferable to use the hydrosilylation reaction which is the production method (B).

The organic compound used as a raw material for the silane compound used in the above-mentioned production method is not limited as long as it has the cyclic structure described in the above [Silane Compound] section. However, examples thereof include hydrogenated polymers of SBS, cycloolefin copolymers, asphalt, and petroleum resins, and petroleum resins are preferable.

Suitable petroleum resins include hydrogenated petroleum resins, partially hydrogenated petroleum resins, and unhydrogenated petroleum resins, which are used as raw materials for the second invention described later.

The organic compound used in the production method (B) has an organic group having a carbon-carbon double bond. Examples of the organic group having a carbon-carbon double bond include vinyl, allyl, butenyl, cyclohexenyl, cyclopentadienyl, and (meth)acryloxypropyl, and a vinyl group, a methacryloxy group, and an acryloxy group are preferable.

The compound having a carbon-carbon double bond and an alkoxysilyl group used in the production method (A) is a compound in which one or more organic groups having a carbon-carbon double bond and one or more alkoxy groups are bonded to a silicon atom, respectively.

Examples of the organic group having a carbon-carbon double bond include vinyl, allyl, butenyl, cyclohexenyl, cyclopentadienyl, and (meth)acryloxypropyl, and a vinyl group, a methacryloxy group, and an acryloxy group are preferable.

Examples of the alkoxy group include a methoxy group, an ethoxy group, an isopropoxy group, and a butoxy group.

The number of alkoxy groups bonded to the silicon atom is preferably one or more, more preferably two or more, and even more preferably three.

Specific examples of the compound having a carbon-carbon double bond and an alkoxysilyl group include vinyltriethoxysilane, vinyltrimethoxysilane, methacryloxypropyltrimethoxysilane and methacryloxypropyltriethoxysilane, and vinyltriethoxysilane and vinyltrimethoxysilane are preferable.

The amount of the compound having a carbon-carbon double bond and an alkoxysilyl group used in the production method (A) is preferably 0.1 to 10% by mass, more preferably 0.2 to 5% by mass, further more preferably 0.5 to 4% by mass, and still further more preferably 1 to 3% by mass with respect to the organic compound having a cyclic structure in terms of silicon atom of the compound having a carbon-carbon double bond and an alkoxysilyl group.

The compound having an alkoxysilyl group and a silicon-hydrogen bond used in the production method (B) is a compound in which one or more hydrogen atoms and one or more alkoxy groups are bonded to a silicon atom, respectively.

Examples of the alkoxy group include a methoxy group, an ethoxy group, an isopropoxy group, and a butoxy group.

The number of alkoxy groups bonded to the silicon atom is preferably one or more, more preferably two or more, and even more preferably three.

Specific examples of the compound having an alkoxysilyl group and a silicon-hydrogen bond include methoxysilane, dimethoxysilane, trimethoxysilane, ethoxysilane, diethoxysilane, methylsilane, dimethylsilane, trimethylsilane, phenylsilane, diphenylsilane and triphenylsilane, and triethoxysilane and trimethoxysilane are preferable.

The amount of the compound having an alkoxysilyl group and a silicon-hydrogen bond used in the production method (B) is preferably 0.1 to 10% by mass, more preferably 0.3 to 8% by mass, further more preferably 0.5 to 5% by mass, and still further more preferably 1 to 4% by mass with respect to the organic compound having a cyclic structure in terms of silicon atom of the compound having an alkoxysilyl group and a silicon-hydrogen bond.

As the compound that generates radicals used in the above-mentioned production method, a compound generally known as a radical polymerization initiator can be used.

The compound that generates radicals can be appropriately selected and used from, for example, various organic peroxides and azo compounds such as azobisisobutyronitrile and azobisisovaleronitrile. Of these, organic peroxides are preferable.

Examples of the organic peroxide include diacyl peroxides such as dibenzoyl peroxide, di-3,5,5-trimethylhexanoyl peroxide, dilauroyl peroxide, didecanoyl peroxide, and di(2,4-dichlorobenzoyl) peroxide; hydroperoxides such as t-butyl hydroperoxide, cumenhydroperoxide, diisopropylbenzenehydroperoxide, and 2,5-dimethylhexane-2,5-dihydroperoxide; dialkyl peroxides such as di-t-butyl peroxide, dicumylperoxide, 2,5-dimethyl-2,5-di(t-butylperoxy)hexane, 1,1-di(t-butylperoxy)cyclohexane, 1,1-di(t-hexylperoxy)cyclohexane, and 2,5-dimethyl-2,5-di(t-butylperoxy)hexin-3,α,α′-bis(t-butylperoxy)diisopropylbenzene; peroxyketals such as 1,1-bis-t-butylperoxy-3,3,5-trimethylcyclohexane and 2,2-bis(t-butylperoxy)butane; alkyl peroxyesters such as 2,5-dimethyl-2,5-di(2-ethylhexanoylperoxy)hexane, n-butyl 4,4-di(t-butylperoxy)valerate, t-butylperoxyoctate, t-butylperoxypivalate, t-butylperoxyneodecanoate, and t-butylperoxybenzoate; peroxycarbonates such as di-2-ethylhexylperoxydicarbonate, diisopropylperoxydicarbonate, di-sec-butylperoxydicarbonate, and t-butylperoxy isopropylcarbonate. Of these, dialkyl peroxides are preferable. In addition, these may be used alone or in combination of two or more.

The amount of the compound that generates radicals used is not particularly limited; however, it is preferably 0.01 to 10% by mass, more preferably 0.01 to 5% by mass, based on the organic compound having a cyclic structure.

The metal catalyst used in the production method (B) is preferably a noble metal catalyst or a transition metal catalyst, more preferably a noble metal catalyst, and even more preferably a platinum catalyst.

In the production method (A), the reaction method is not limited as long as the reaction proceeds sufficiently. However, it is preferable to use (1) a method of mixing an organic compound having a cyclic structure, a compound having a carbon-carbon double bond and an alkoxysilyl group, and a compound that generates radicals, and generating radicals by heating or the like to react, (2) a method of dissolving an organic compound having a cyclic structure, a compound having a carbon-carbon double bond and an alkoxysilyl group, and a compound that generates radicals in an organic solvent, and generating radicals by heating or the like to react. Since a method that does not use an organic solvent is preferable, the method (1) of mixing an organic compound having a cyclic structure, a compound having a carbon-carbon double bond and an alkoxysilyl group, and a compound that generates radicals, and generating radicals by heating or the like to react is more preferable.

In the case of the method (1), it is preferable to mix an organic compound having a cyclic structure with a compound having a carbon-carbon double bond and an alkoxysilyl group, add a compound that generates radicals and heat the mixture to react the organic compound having a cyclic structure with a carbon-carbon double bond portion of the compound having a carbon-carbon double bond and an alkoxysilyl group to obtain a silane compound.

The reaction temperature is preferably 100 to 300° C., more preferably 100 to 200° C.

In the case of the method (2), it is preferable to dissolve an organic compound having a cyclic structure in an organic solvent, mix it with a compound having a carbon-carbon double bond and an alkoxysilyl group, add a compound that generates radicals and heat the mixture to react the organic compound having a cyclic structure with a carbon-carbon double bond portion of the compound having a carbon-carbon double bond and an alkoxysilyl group to obtain a silane compound.

Examples of the organic solvent that can be used in the present method include hydrocarbon solvents such as pentane, hexane, heptane, cyclohexane, toluene, xylene, and decahydronaphthalin, halogenated hydrocarbon solvents such as chlorobenzene, dichlorobenzene, and trichlorobenzene, and liquefied α-olefin.

The reaction temperature is preferably −50 to 300° C., more preferably 0 to 300° C., further more preferably 100 to 300° C., and still further more preferably 100 to 200° C.

In the production method (B), the reaction method is not limited as long as the reaction proceeds sufficiently. However, the reaction temperature when the reaction is carried out in the presence of a compound that generates radicals is preferably 0 to 200° C., more preferably 130 to 180° C. In addition, the reaction temperature when the reaction is carried out in the presence of a metal catalyst is preferably 40 to 100° C.

### [Asphalt Composition]

The asphalt composition according to one aspect of the first invention contains the silane-containing compound and straight asphalt, and the content of straight asphalt is preferably 70.00 to 99.99% by mass.

### <Straight Asphalt>

Straight asphalt is used as an asphalt base oil.

As the straight asphalt, asphalt specified in JIS K 2207 or a mixture thereof can be used. As the straight asphalt, it is preferable to use an equivalent with penetration grade of 40-60 to 200-300.

The content of straight asphalt with respect to the entire asphalt composition is preferably 70.00 to 99.99% by mass, more preferably 90 to 99.90% by mass.

In the asphalt composition, as asphalt base oil other than straight asphalt, solvent deasphalted asphalt such as propane deasphalted asphalt, and asphalt such as blown asphalt and semi-blown asphalt may be used in combination. Further, it is preferable that an aromatic heavy mineral oil is contained.

Solvent deasphalted asphalt corresponds to the residue obtained by extracting solvent deasphalted oil (high-viscosity lubricating oil fraction) from vacuum-distilled residual oil (see “Shinsekiyu Jiten”, edited by Sekiyu Gakkai, 1982, page 308). In particular, when propane or propane and butane are used as the solvent, it is called propane deasphalted asphalt.

The blown asphalt is, for example, the asphalt defined in JIS K 2207.

Semi-blown asphalt is, for example, the semi-blown asphalt as defined in Table 3.3.4 on page 51 of “Asphalt Hosou Youkou”, published by Shadan Houjin Nihon Dourou Kyoukai, Jan. 13, 1997.

### (Aromatic Heavy Mineral Oil)

As the aromatic heavy mineral oil in the asphalt composition, it is possible to use a solvent-extracted oil, that is, extract, at the time of obtaining bright stock (heavy lubricating oil) by removing the vacuum-distilled residual oil of crude oil with propane or the like and further extracting the obtained solvent deasphalted oil with a polar solvent such as furfural. In particular, in the asphalt composition according to one aspect of the first invention, it is preferable to add an extract as an aromatic heavy mineral oil.

In the asphalt composition, the role of the extract is to increase the solubility of the thermoplastic elastomer in the asphalt and prevent the occurrence of separation in the storage stability. When the thermoplastic elastomer is added in a large amount, the amount of the extract required also increases. Further, when an extract more than necessary is added with respect to the amount of the thermoplastic elastomer added, the elastic modulus of the asphalt composition decreases.

The content of the extract in the entire asphalt composition is determined in consideration of penetration, softening point, storage stability, complex modulus and dynamic stability (DS) in wheel tracking test indicating strength, and bending work amount and bending stiffness indicating low temperature properties. In the range examined in the present embodiment, the content of the extract in the entire asphalt composition is preferably 2.0% by mass or more and 8.0% by mass or less. However, it is not particularly necessary to contained the extract, and the extract may not be contained.

### (SBS)

In addition to straight asphalt and other asphalt base oils, the asphalt composition can contain SBS (styrene-butadiene-styrene copolymer) as a reinforcing material.

SBS is a thermoplastic elastomer added as a reinforcing material. The performance of SBS can be estimated mainly from the molecular weight and styrene content thereof. The styrene content referred to herein is the mass % of styrene contained in SBS.

Currently, the weight average molecular weight of SBS, which is easily available industrially, is 120,000 or more and 250,000 or less. The styrene content in SBS is 25.0% by mass or more and 35.0% by mass or less, preferably 27.0% by mass or more and 33.0% by mass or less of the entire SBS.

In addition to the above, SBSs having different molecular weights and styrene contents are available, and the molecular weights of these SBSs are 80,000 or more and 90,000 or less. Further, the styrene content is 25.0% by mass or more and 50.0% by mass or less of the entire SBS.

In the asphalt composition, it is not particularly necessary to contain SBS, and SBS may not be contained. However, in order to solve the above-mentioned problems, the content of SBS in the entire asphalt composition is preferably 7.0% by mass or less. By setting the SBS content to 7.0% by mass or less, it is possible to maintain the asphalt continuous phase, and it is possible to improve the water resistance of the mixture having a dense particle size and having excellent water impermeability. On the other hand, when it is desired to produce an asphalt mixture having high drainage or water permeability in which voids are positively provided inside the pavement, by setting the content of SBS in the entire asphalt composition of the present embodiment to exceed 7.0% by mass, it becomes possible to produce an asphalt composition having high drainage or water permeability by causing a phase transition of SBS while solving the above-mentioned problems.

In the asphalt composition, only one kind of SBS may be mixed, or two or more kinds of SBS having a specific molecular structure may be selected and mixed. When only one kind of SBS is mixed, it is possible to eliminate the complexity of selecting and mixing two or more types of SBS, and it is possible to reduce the labor for production, which is preferable.

### (Production of Asphalt Composition)

As described above, the asphalt composition may be produced by any method as long as the asphalt composition contains a silane-containing compound and straight asphalt and the content of the straight asphalt is 70.00 to 99.99% by mass. However, it is preferable to produce by the following method.

An extract is mixed with the straight asphalt and stirred and mixed for a predetermined time by a stirring device under the conditions of, for example, a rotation speed of 2,000 rpm or more and 4,000 ppm or less at 140° C. or higher to obtain an asphalt base oil as an asphalt substrate. In this step, a predetermined amount of SBS may be added at the same time, or SBS may be added at the same time to obtain an asphalt composition in one step. When SBS is added, the temperature is preferably 180° C. or higher.

In addition, a predetermined amount of SBS may be added after obtaining the asphalt base oil. When SBS is added, it is stirred and mixed for a predetermined time by a stirring device under the conditions of, for example, a rotation speed of 2,000 rpm or more and 4,000 ppm or less at 180° C. or higher to obtain an asphalt composition.

In the present production method, the silane-containing compound may be added in either a step of obtaining an asphalt base oil or a step of mixing SBS, or may be added to the obtained asphalt composition, depending on its shape and physical properties. When the asphalt composition is obtained in one step, the silane-containing compound may be added at the same time, or may be added to the obtained asphalt composition.

According to the above method, a homogeneous composition having high water resistance can be efficiently obtained.

### [Asphalt Mixture]

The asphalt mixture according to one aspect of the first invention contains the asphalt composition and an aggregate, and the content of the aggregate is 80 to 99% by mass.

In the asphalt mixture, the content of the aggregate is preferably 80 to 99% by mass, more preferably 90 to 97% by mass, based on the entire asphalt mixture.

As the asphalt mixture, an asphalt mixture having desired properties is obtained by adding an aggregate having a predetermined particle size to the asphalt composition and mixing at a predetermined rotation speed. The temperature at which the asphalt composition and the aggregate are mixed is preferably about 170 to 180° C.

Since the asphalt mixture according to one aspect of the first invention contains an asphalt composition composed of the above-mentioned component composition, it is possible to improve peeling resistance and it is possible to suppress the peeling of asphalt and improve water resistance.

### [Second Invention]

Hereinafter, a modified hydrogenated petroleum resin, a method of producing the modified hydrogenated petroleum resin, and a hot-melt adhesive and a pressure-sensitive adhesive containing 1 to 70% by mass of the modified hydrogenated petroleum resin will be described in order. In addition, an asphalt composition and an asphalt mixture will also be described.

### [Modified Hydrogenated Petroleum Resin]

A modified hydrogenated petroleum resin according to one aspect of the second invention satisfies the following (A1) to (A4):
(A1) a bromine value of 0.1 to 10.0
(A2) containing 0.1 to 10% by mass of silicon element in terms of silicon atom
(A3) a weight average molecular weight of 500 to 5,000
(A4) a molecular weight distribution (Mw/Mn) of 1.1 to 3.5.

As used herein, a “petroleum resin” refers to a resin obtained by polymerizing or copolymerizing one or more unsaturated compounds selected from aliphatic olefins or aliphatic diolefins having 4 to 10 carbon atoms, or aromatic compounds having 8 or more carbon atoms and having an olefinically unsaturated bond, which are obtained as by-products during the production of olefins such as ethylene by thermal decomposition of petroleum such as naphtha.

The petroleum resin can be, for example, roughly classified into an “aliphatic petroleum resin” obtained by polymerizing an aliphatic olefin or an aliphatic diolefin, an “aromatic petroleum resin” obtained by polymerizing an aromatic compound having an olefinic unsaturated bond, and an “aliphatic-aromatic copolymerized petroleum resin” obtained by copolymerizing an aliphatic olefin or an aliphatic diolefin with an aromatic compound having an olefinically unsaturated bond.

Examples of the aliphatic olefin having 4 to 10 carbon atoms include butene, pentene, hexene, and heptene. In addition, examples of the aliphatic diolefin having 4 to 10 carbon atoms include butadiene, pentadiene, isoprene, piperylene, cyclopentadiene, dicyclopentadiene, and methylpentadiene. Further, examples of the aromatic compound having 8 or more carbon atoms and having an olefinically unsaturated bond include styrene, α-methylstyrene, β-methylstyrene, vinyltoluene, vinylxylene, inden, methylinden, and ethylinden.

Further, the raw material compound of the petroleum resin all does not necessarily have to be a by-product during the production of olefins by thermal decomposition of petroleum such as naphtha, and a chemically synthesized unsaturated compound may be used.

Preferable examples of the petroleum resin include a dicyclopentadiene-based petroleum resin obtained by polymerizing cyclopentadiene or dicyclopentadiene, a dicyclopentadiene-styrene-based petroleum resin obtained by copolymerizing the cyclopentadiene or dicyclopentadiene with styrene, a C5-based petroleum resins obtained by polymerizing isoprene or piperylene, and a C9-based petroleum resin obtained by polymerizing a C9 monomer such as inden and vinyltoluene.

As used herein, a “hydrogenated petroleum resin” is a petroleum resin in which a hydrogen atom is added to the petroleum resin. Examples of the hydrogenated petroleum resin include a fully hydrogenated petroleum resin in which an unsaturated bond does not substantially remain and a partially hydrogenated petroleum resin in which an unsaturated bond remains, and a completely hydrogenated petroleum resin is preferable.

As the hydrogenated petroleum resin, a hydrogenated aliphatic-aromatic copolymerized petroleum resin is preferable.

The modified hydrogenated petroleum resin according to one aspect of the second invention contains 0.1 to 10% by mass of silicon element in terms of silicon atom. The silicon element is preferably derived from an organic silane structure.

The content of silicon element can be measured by ICP emission spectroscopic analysis, and specifically can be measured by a method described in Examples.

The modified hydrogenated petroleum resin of the present invention contains 0.1 to 10% by mass, preferably 0.3 to 8% by mass, more preferably 0.5 to 5% by mass, and further more preferably 1 to 4% by mass of silicon element in terms of silicon atom.

The modified hydrogenated petroleum resin according to one aspect of the second invention is preferably a silane modified hydrogenated petroleum resin having an organic silane structure. Of these, a modified hydrogenated petroleum resin in which an alkoxysilyl group is bonded to the main chain of the hydrogenated petroleum resin via a bonding portion is preferable.

Here, “an alkoxysilyl group is bonded to the main chain of the hydrogenated petroleum resin via a bonding portion” means, for example, to a carbon atom contained in a hydrogenated polymer (hydrogenated petroleum resin) obtained by polymerizing an aliphatic olefin, an aliphatic diolefin, and an aromatic compound having an olefinically unsaturated bond as described above and adding a hydrogen atom, a direct bond is bonded and an alkoxysilyl group is further bonded.

The alkoxysilyl group is preferably a trialkoxysilyl group having an alkoxy group having 1 to 20 carbon atoms which may be linear or branched, and is more preferably a trialkoxysilyl group having an alkoxy group having 1 to 10 carbon atoms which may be linear or branched. Specific examples thereof include a trimethoxysilyl group, a triethoxysilyl group, and a tripropoxysilyl group, and a trimethoxysilyl group and a triethoxysilyl group are preferable.

The bonding portion may be any divalent or higher organic group that can be bonded to the carbon atom of the main chain of the hydrogenated petroleum resin and can be bonded to an alkoxysilyl group, and is preferably an alkylene group, more preferably an alkylene group having 2 to 3 carbon atoms.

### <Characteristics of Modified Hydrogenated Petroleum Resin>

The bromine value (gBr₂/100 g) of the modified hydrogenated petroleum resin according to one aspect of the second invention is preferably 0.1 to 10.0, more preferably 0.5 to 5.0, and further more preferably 1.0 to 3.0.

When the bromine value is in the above range, the modified hydrogenated petroleum resin has a faint odor and is excellent in colorlessness.

In the modified hydrogenated petroleum resin according to one aspect of the second invention, an integral ratio of aromatic hydrogen [integral value of peak in 6.5 to 7.5 ppm region/(sum of integral value of peak in 0 to 3.0 ppm region and integral value of peak in 6.5 to 7.5 ppm region)] in ¹H-NMR measurement is preferably 0 to 15%, more preferably 0 to 10%, and further more preferably 0 to 5%.

The integral ratio of aromatic hydrogen in ¹H-NMR measurement can be specifically measured by a method described in Examples.

The integral ratio of aromatic hydrogen in the ¹H-NMR measurement is a value indicating the ratio of aromatic moiety in the modified hydrogenated petroleum resin of the preset invention. When the integral ratio of aromatic hydrogen in ¹H-NMR measurement is in the above range, the odor is faint and the colorlessness is excellent.

The weight average molecular weight (Mw) of the modified hydrogenated petroleum resin according to one aspect of the second invention is 500 to 5,000, preferably 600 to 3,000, more preferably 700 to 2,000, and further more preferably 800 to 1,500.

The weight average molecular weight is an index showing the fluidity at the time of melting, and the smaller the weight average molecular weight, the larger the fluidity at the time of melting, and the better the coatability when applied to a hot-melt adhesive. When the weight average molecular weight is in the above range, the coatability becomes excellent when applied to a hot-melt adhesive while maintaining the heat resistance, which is the effect of the present invention.

The weight average molecular weight can be specifically measured by a method described in Examples.

The molecular weight distribution (weight average molecular weight/number average molecular weight, Mw/Mn) of the modified hydrogenated petroleum resin according to one aspect of the second invention is 1.1 to 3.5, preferably 1.3 to 3.0, more preferably 1.5 to 3.0, and further more preferably 2.0 to 2.5.

The molecular weight distribution represents the degree of dispersion of the molecular weight, and becomes wide when the low molecular weight component or the high molecular weight component is extremely large.

The molecular weight distribution can be specifically measured by a method described in Examples.

When the molecular weight distribution is in the above range, the odor is faint and the coatability is excellent.

The number average molecular weight (Mn) of the modified hydrogenated petroleum resin according to one aspect of the second invention is preferably 100 to 4,500, more preferably 250 to 2,500, and further more preferably 300 to 1,500.

The softening point of the modified hydrogenated petroleum resin according to one aspect of the second invention is preferably 60 to 150° C., more preferably 80 to 140° C., and further more preferably 90 to 130° C.

The softening point can be measured by the ring-and-ball method, and can be specifically measured by a method described in Examples.

When used in a hot-melt adhesive, the balance between heat resistance and low temperature coating property is excellent as the softening point is in the above range.

The modified hydrogenated petroleum resin according to one aspect of the second invention has a volatile component content of preferably 1.0% by mass or less when heated at 150° C. for 20 minutes.

The color density of the modified hydrogenated petroleum resin according to one aspect of the second invention at the time of melting is preferably 1 to 3 and more preferably 1 to 2 in terms of the Gardner color scale. When the color density is in the above range, it is excellent in colorlessness and improves the appearance of the product after adhesion when used as a component of an adhesive.

### [Production Method of Modified Hydrogenated Petroleum Resin]

The method of producing the modified hydrogenated petroleum resin according to one aspect of the second invention is not particularly limited; however, the following method is preferably used from the viewpoint of efficiently introducing silane into the resin and improving the heat resistance.

The method of producing the modified hydrogenated petroleum resin is preferably a method of reacting a hydrogenated petroleum resin with a compound having a carbon-carbon double bond and an alkoxysilyl group in the presence of a compound that generates radicals.

The hydrogenated petroleum resin used in the production method has the same meaning as the “hydrogenated petroleum resin” described in the above [Modified Hydrogenated Petroleum Resin] section, and is specifically a petroleum resin in which a hydrogen atom is added to the petroleum resin. The hydrogenated petroleum resin includes a fully hydrogenated petroleum resin in which an unsaturated bond does not substantially remain and a partially hydrogenated petroleum resin in which an unsaturated bond remains, and the hydrogenated petroleum resin used in the production method of the present invention is preferably a completely hydrogenated petroleum resin.

As the hydrogenated petroleum resin, a hydrogenated aliphatic-aromatic copolymerized petroleum resin is preferable.

The petroleum resin used as a raw material for hydrogenated petroleum resin has the same meaning as the “petroleum resin” described in the above [Modified Hydrogenated Petroleum Resin] section, and is specifically as follows.

The petroleum resin is a resin obtained by polymerizing or copolymerizing one or more unsaturated compounds selected from aliphatic olefins or aliphatic diolefins having 4 to 10 carbon atoms, or aromatic compounds having 8 or more carbon atoms and having an olefinically unsaturated bond, which are obtained as by-products during the production of olefins such as ethylene by thermal decomposition of petroleum such as naphtha.

The petroleum resin can be, for example, roughly classified into an “aliphatic petroleum resin” obtained by polymerizing an aliphatic olefin or an aliphatic diolefin, an “aromatic petroleum resin” obtained by polymerizing an aromatic compound having an olefinic unsaturated bond, and an “aliphatic-aromatic copolymerized petroleum resin” obtained by copolymerizing an aliphatic olefin or an aliphatic diolefin with an aromatic compound having an olefinically unsaturated bond.

Examples of the aliphatic olefin having 4 to 10 carbon atoms include butene, pentene, hexene, and heptene. In addition, examples of the aliphatic diolefin having 4 to 10 carbon atoms include butadiene, pentadiene, isoprene, piperylene, cyclopentadiene, dicyclopentadiene, and methylpentadiene. Further, examples of the aromatic compound having 8 or more carbon atoms and having an olefinically unsaturated bond include styrene, α-methylstyrene, β-methylstyrene, vinyltoluene, vinylxylene, inden, methylinden, and ethylinden.

Further, the raw material compound of the petroleum resin all does not necessarily have to be a by-product during the production of olefins by thermal decomposition of petroleum such as naphtha, and a chemically synthesized unsaturated compound may be used.

Preferable examples of the petroleum resin include a dicyclopentadiene-based petroleum resin obtained by polymerizing cyclopentadiene or dicyclopentadiene, a dicyclopentadiene-styrene-based petroleum resin obtained by copolymerizing the cyclopentadiene or dicyclopentadiene with styrene, a C5-based petroleum resin obtained by polymerizing isoprene or piperylene, and a C9-based petroleum resin obtained by polymerizing a C9 monomer such as inden and vinyltoluene.

The compound having a carbon-carbon double bond and an alkoxysilyl group used in the production method is a compound in which one or more organic groups having a carbon-carbon double bond and one or more alkoxy groups are bonded to a silicon atom, respectively.

Examples of the organic group having a carbon-carbon double bond include vinyl, allyl, butenyl, cyclohexenyl, cyclopentadienyl, and (meth)acryloxypropyl, and a vinyl group, a methacryloxy group, and an acryloxy group are preferable.

Examples of the alkoxy group include a methoxy group, an ethoxy group, an isopropoxy group, and a butoxy group.

The number of alkoxy groups bonded to the silicon atom is preferably one or more, more preferably two or more, and even more preferably three.

Specific examples of the compound having a carbon-carbon double bond and an alkoxysilyl group include vinyltriethoxysilane, vinyltrimethoxysilane, methacryloxypropyltrimethoxysilane and methacryloxypropyltriethoxysilane, and vinyltriethoxysilane and vinyltrimethoxysilane are preferable.

The amount of the compound having a carbon-carbon double bond and an alkoxysilyl group used in the production method is preferably 0.1 to 10% by mass, more preferably 0.3 to 8% by mass, further more preferably 0.5 to 5% by mass, and still further more preferably 1 to 4% by mass with respect to the hydrogenated petroleum resin in terms of silicon atom of the compound having a carbon-carbon double bond and an alkoxysilyl group.

As the compound that generates radicals used in the above-mentioned production method, a compound generally known as a radical polymerization initiator can be used.

The compound that generates radicals can be appropriately selected and used from, for example, various organic peroxides and azo compounds such as azobisisobutyronitrile and azobisisovaleronitrile. Of these, organic peroxides are preferable.

Examples of the organic peroxide include diacyl peroxides such as dibenzoyl peroxide, di-3,5,5-trimethylhexanoyl peroxide, dilauroyl peroxide, didecanoyl peroxide, and di(2,4-dichlorobenzoyl) peroxide; hydroperoxides such as t-butyl hydroperoxide, cumenhydroperoxide, diisopropylbenzenehydroperoxide, and 2,5-dimethylhexane-2,5-dihydroperoxide; dialkyl peroxides such as di-t-butyl peroxide, dicumylperoxide, 2,5-dimethyl-2,5-di(t-butylperoxy)hexane, 1,1-di(t-butylperoxy)cyclohexane, 1,1-di(t-hexylperoxy)cyclohexane, and 2,5-dimethyl-2,5-di(t-butylperoxy)hexin-3,α,α′-bis(t-butylperoxy)diisopropylbenzene; peroxyketals such as 1,1-bis-t-butylperoxy-3,3,5-trimethylcyclohexane and 2,2-bis(t-butylperoxy)butane; alkyl peroxyesters as such 2,5-dimethyl-2,5-di(2-ethylhexanoylperoxy)hexane, n-butyl 4,4-di(t-butylperoxy)valerate, t-butylperoxyoctate, t-butylperoxypivalate, t-butylperoxyneodecanoate, and t-butylperoxybenzoate; peroxycarbonates such as di-2-ethylhexylperoxydicarbonate, diisopropylperoxydicarbonate, di-sec-butylperoxydicarbonate, and t-butylperoxy isopropylcarbonate. Of these, dialkyl peroxides are preferable. In addition, these may be used alone or in combination of two or more.

The amount of the compound that generates radicals used is not particularly limited; however, it is preferably 0.01 to 10% by mass, more preferably 0.01 to 5% by mass, based on the hydrogenated petroleum resin.

As described above, a preferable method of producing a modified hydrogenated petroleum resin according to one aspect of the second invention is a method of reacting a hydrogenated petroleum resin with a compound having a carbon-carbon double bond and an alkoxysilyl group in the presence of a compound that generates radicals. The reaction method is not limited as long as the reaction proceeds sufficiently. However, it is preferable to use (1) a method of mixing a molten hydrogenated petroleum resin, a compound having a carbon-carbon double bond and an alkoxysilyl group, and a compound that generates radicals, and generating radicals by heating or the like to react, (2) a method of dissolving a hydrogenated petroleum resin, a compound having a carbon-carbon double bond and an alkoxysilyl group, and a compound that generates radicals in an organic solvent, and generating radicals by heating or the like to react. The method (1) of mixing a molten hydrogenated petroleum resin, a compound having a carbon-carbon double bond and an alkoxysilyl group, and a compound that generates radicals, and generating radicals by heating or the like to react is more preferable.

In the case of the method (1), it is preferable to melt a hydrogenated petroleum resin, mix it with a compound having a carbon-carbon double bond and an alkoxysilyl group, add a compound that generates radicals and heat the mixture to react the hydrogenated petroleum resin with a carbon-carbon double bond portion of the compound having a carbon-carbon double bond and an alkoxysilyl group to obtain a modified hydrogenated petroleum resin.

In the method, when the melt viscosity of the hydrogenated petroleum resin is low, it is preferable to react while stirring with a conventional reactor. When the melt viscosity of the hydrogenated petroleum resin is high, it is preferable to react while melting and kneading using a roll mill, a Banbury mixer, an extruder, etc.

The reaction temperature is preferably 100 to 300° C., more preferably 100 to 200° C.

In the case of the method (2), it is preferable to dissolve a hydrogenated petroleum resin in an organic solvent, mix it with a compound having a carbon-carbon double bond and an alkoxysilyl group, add a compound that generates radicals and heat the mixture to react the hydrogenated petroleum resin with a carbon-carbon double bond portion of the compound having a carbon-carbon double bond and an alkoxysilyl group to obtain a modified hydrogenated petroleum resin.

Examples of the organic solvent that can be used in the present method include hydrocarbon solvents such as pentane, hexane, heptane, cyclohexane, toluene, xylene, and decahydronaphthalin, halogenated hydrocarbon solvents such as chlorobenzene, dichlorobenzene, and trichlorobenzene, and liquefied α-olefin.

The reaction temperature is preferably-50 to 300° C., more preferably 0 to 300° C., further more preferably 100 to 300° C., and still further more preferably 100 to 200° C.

### [Hot-Melt Adhesive]

The hot-melt adhesive according to one aspect of the second invention contains 1 to 70% by mass of the modified hydrogenated petroleum resin.

That is, the hot-melt adhesive contains 1 to 70% by mass of a modified hydrogenated petroleum resin satisfying the following (A1) to (A4):
(A1) a bromine value of 0.1 to 10.0
(A2) containing 0.1 to 10% by mass of silicon element in terms of silicon atom
(A3) a weight average molecular weight of 500 to 5,000
(A4) a molecular weight distribution (Mw/Mn) of 1.1 to 3.5.

By adjusting the molecular weight, the molecular weight distribution, the glass transition temperature, and the like thereof, the modified hydrogenated petroleum resin can be used as a component having the properties of a tackifier, a component having the properties of a base polymer, or a component having both the properties of a tackifier and a base polymer among components constituting a hot-melt adhesive; however, it is preferably used as a tackifier. When used as any of the components, it is possible to improve the heat resistance of the obtained hot-melt adhesive, and it is possible to obtain a colorless hot-melt adhesive having a faint odor.

When the modified hydrogenated petroleum resin is used as a tackifier, the content of the modified hydrogenated petroleum resin is preferably 5% by mass or more, more preferably 10% by mass or more, further more preferably 20% by mass or more, still further more preferably 25% by mass or more, and is preferably 70% by mass or less, more preferably 60% by mass or less, further more preferably 40% by mass or less in the hot-melt adhesive.

The hot-melt adhesive may contain a base polymer, a tackifier, a plasticizer, and an additive in addition to the modified hydrogenated petroleum resin.

### <Base Polymer>

The hot-melt adhesive preferably further contains a base polymer.

As used herein, the “base polymer” according to the second invention refers to a polymer contained most in polymer components used as components other than the modified hydrogenated petroleum resin.

Specific examples of the base polymer include natural rubber, an olefin-based elastomer, a styrene-based elastomer, and an olefin-based plastomer, and the olefin-based elastomer and the styrene-based elastomer are preferred. In addition, examples of the base polymer used in a reactive hot-melt adhesive include polymers having a silane-containing group and an isocyanate group that undergo a condensation reaction with water.

The elastomer is not limited by the density as long as it has rubber elastic properties, and may be chemically crosslinked or may not be chemically crosslinked.

The plastomer is not limited by the density as long as it is plastically deformed, and may be chemically crosslinked or may not be chemically crosslinked.

These base polymers may be used alone or in combination of two or more.

Examples of the olefin-based elastomer include an ethylene-based olefin polymer, an amorphous olefin polymer, a propylene-based elastomer, an ethylene-vinyl acetate copolymer, and an ethylene-acrylic acid ester copolymer, and the propylene-based elastomer and the ethylene-based olefin polymer are preferable.

The ethylene-based olefin polymer is an olefin polymer having an ethylene unit as a main constituent unit, and specific examples thereof include polyethylene and a copolymer of ethylene and olefins having 3 to 10 carbon atoms. Here, the main constituent unit refers to a constituent unit contained most among constituent units constituting the polymer. In the present specification, the polymer containing the largest amount of ethylene units but having the same amount as other constituent units is referred to as an ethylene-based olefin polymer. The ethylene-based olefin polymer is not particularly limited as long as it can be used as the base polymer of the hot-melt adhesive, and from the viewpoint of the adhesion of the hot-melt adhesive, an ethylene-α-olefin copolymer is preferred. Specific examples of the α-olefin include propylene, 1-butene, 1-pentene, 4-methyl-1-pentene, 1-hexene, 1-octene, 1-decene, 1-dodecene, 1-tetradecene, 1-hexadecene, 1-octadecene, and 1-eicosene, and one or more kinds of these α-olefins may be used. Among these α-olefins, 1-octene is preferred. From the viewpoint of the adhesion of the hot-melt adhesive, an ethylene-1-octene copolymer is more preferred, and an ethylene-1-octene copolymer containing 5% by mass to 50% by mass of structural units derived from 1-octene is more preferred.

The melting point of the ethylene-based olefin polymer is preferably 60° C. to 120° C., and more preferably 60° C. to 90° C. from a viewpoint of thermal creep resistance. The melting point of the ethylene-based olefin polymer can be measured by differential scanning calorimetry. Among the ethylene-based olefin polymers, an amorphous ethylene-based olefin polymer belongs to the amorphous olefin polymer described below.

The amorphous olefin polymer is one or more homopolymers or copolymers selected from a group consisting of linear or branched α-olefins or dienes having 2 to 24 carbon atoms, and examples of the amorphous olefin polymer include, but are not limited to, an ethylene-propylene copolymer, atactic polypropylene, polybutene, atactic poly1-butene, polybutadiene, polyisoprene, and amorphous polyalphaolefin.

Examples of polybutene include respective homopolymers of isobutene and normal butene, a copolymer of isobutene and normal butene, and a hydrogenated product thereof.

Examples of polybutadiene include respective homopolymers of 1,2-butadiene and 1,4-butadiene, a copolymer of 1,2-butadiene and 1,4-butadiene, and a hydrogenated product thereof, and may have a hydroxy group at a terminal.

Examples of polyisoprene include a homopolymer or a copolymer of isoprene and a hydrogenated product thereof, and may have a hydroxy group at a terminal.

Examples of amorphous polyalphaolefin include a homopolymer or a copolymer of olefins having 2 to 6 carbon atoms.

The propylene-based elastomer is an elastomer having a propylene unit as a main structural unit, and examples of the propylene-based elastomer include low crystalline polypropylene.

A content of vinyl acetate in the ethylene-vinyl acetate copolymer is preferably 5% by mass to 50% by mass, and more preferably 10% by mass to 40% by mass.

As the styrene-based elastomer, a styrene-based block copolymer is preferred.

The styrene-based block copolymer is a copolymer obtained by block-copolymerizing a styrene-based compound and a conjugated diene compound, and usually has a styrene-based compound block and a conjugated diene compound block.

Here, examples of the “styrene-based compound” include styrene, o-methylstyrene, p-methylstyrene, p-tert-butylstyrene, 1,3-dimethylstyrene, α-methylstyrene, vinylnaphthalene, and vinylanthracene. Styrene is particularly preferred. These styrene-based compounds may be used alone or in combination.

The “conjugated diene compound” means a diolefin compound having at least a pair of conjugated double bonds. Specific examples of the “conjugated diene compound” include 1,3-butadiene, 2-methyl-1,3-butadiene (or isoprene), 2,3-dimethyl-1,3-butadiene, 1,3-pentadiene, and 1,3-hexadiene. 1,3-butadiene and 2-methyl-1,3-butadiene are particularly preferred. These conjugated diene compounds may be used alone or in combination.

The styrene-based block copolymer may be a non-hydrogenated product or a hydrogenated product. Specific examples of the “non-hydrogenated product of the styrene-based block copolymer” include one in which a block based on the conjugated diene compound is not hydrogenated. Specific examples of the “hydrogenated product of the styrene-based block copolymer” include a block copolymer in which all or a part of a block based on the conjugated diene compound is hydrogenated.

A hydrogenated proportion of the “hydrogenated product of the styrene-based block copolymer” can be indicated by a “hydrogenation rate”. The “hydrogenation rate” of the “hydrogenated product of the styrene-based block copolymer” refers to a proportion of double bonds, which are converted into saturated hydrocarbon bonds by hydrogenation, in all aliphatic double bonds contained in the blocks based on the conjugated diene compound. The “hydrogenation rate” may be measured by an infrared spectrophotometer, a nuclear magnetic resonance spectrometer, and the like.

Specific examples of the “non-hydrogenated product of the styrene-based block copolymer” include a styrene-isoprene-styrene block copolymer (also referred to as “SIS”) and a styrene-butadiene-styrene block copolymer (also referred to as “SBS”). Specific examples of the “hydrogenated product of the styrene-based block copolymer” include a hydrogenated styrene-isoprene-styrene block copolymer (also referred to as “SEPS”) and a hydrogenated styrene-butadiene-styrene block copolymer (also referred to as “SEBS”).

These styrene-based block copolymers may be used alone or in combination.

From a viewpoint of adhesive strength of the hot-melt adhesive, in the styrene-based block copolymer, a proportion of a styrene block contained in the styrene-based block copolymer (a styrene content) is preferably 5% by mass to 50% by mass, and more preferably 10% by mass to 40% by mass.

From a viewpoint of cohesion, the content of the base polymer in the hot-melt adhesive is preferably 5% by mass or more, more preferably 10% by mass or more, still more preferably 20% by mass or more, and yet still more preferably 30% by mass or more, and is preferably 80% by mass or less, more preferably 70% by mass or less, still more preferably 60% by mass or less, and yet still more preferably 50% by mass or less.

The glass transition temperature of the base polymer is preferably −20° C. to 100° C., and more preferably −20° C. to 60° C.

### <Tackifier>

The hot-melt adhesive preferably further contains a tackifier.

Examples of the tackifier include those that are formed of a rosin derivative resin, a polyterpene resin, an oil-soluble phenol resin, and the like, and are solid, semi-solid or liquid at a room temperature. Specific examples include natural rosin, modified rosin, hydrogenated rosin, glycerol esters of natural rosin, glycerol esters of modified rosin, pentaerythritol esters of natural rosin, pentaerythritol esters of modified rosin, pentaerythritol esters of hydrogenated rosin, a copolymer of natural terpene, a three-dimensional polymer of natural terpene, a hydrogenated derivative of a copolymer of hydrogenated terpene, a polyterpene resin, and a hydrogenated derivative of a phenolic modified terpene resin.

Further, examples of the tackifier may include an aliphatic petroleum hydrocarbon resin, a hydrogenated derivative of an aliphatic petroleum hydrocarbon resin, an aromatic petroleum hydrocarbon resin, a hydrogenated derivative of an aromatic petroleum hydrocarbon resin, a cyclic aliphatic petroleum hydrocarbon resin, and a hydrogenated derivative of a cyclic aliphatic petroleum hydrocarbon resin, which are unmodified petroleum resins.

The tackifiers may be used alone or in a combination of two or more.

Of the above tackifiers, it is preferable to use a hydrogenated additive in consideration of compatibility with the base polymer.

Examples of commercially available products of the tackifier include the following.

Examples of tackifiers produced using crude oil and raw materials obtained in a naphtha refining process include “I-MARV” (manufactured by Idemitsu Kosan Co., Ltd.), “ARKON” (manufactured by Arakawa Chemical Industries Co., Ltd.), “Quintone” (manufactured by Japan Zeon Corporation), “T-REZ” (manufactured by ENEOS Corporation), “Escorez”, “Oppera” (above manufactured by ExxonMobil Chemical), “Eastotac”, “Regalite”, “Regalrez”, “Plastolyn” (above manufactured by Eastman), “Sukorez” (manufactured by Kolon Industries), and “Wingtack”, “Norsolene” (above manufactured by Cray Valley) (all trade names and registered trademarks).

Examples of tackifiers produced by using an essential oil obtained from orange or the like as a raw material include “CLEARON” (manufactured by Yasuhara Chemical Co., Ltd.), and “Sylvalite”, “Sylvares” (manufactured by KRATON) (all trade names and registered trademarks).

Examples of tackifiers produced using raw materials such as rosin include “HARITACK”, “Neotoll (registered trademark)” (manufactured by Harima Chemicals), “Ester Gum” and “PENSEL (registered trademark)” (manufactured by Arakawa Chemical Industries Co., Ltd.) (all trade names).

From the viewpoint of improving the adhesion, the content of the tackifier in the hot-melt adhesive is preferably 5% by mass or more, more preferably 10% by mass or more, still more preferably 20% by mass or more, and yet still more preferably 30% by mass or more, and is preferably 80% by mass or less, more preferably 70% by mass or less, still more preferably 60% by mass or less, and yet still more preferably 50% by mass or less.

A softening point of the tackifier is preferably −20° C. or higher, more preferably −15° C. or higher, and still more preferably −10° C. or higher, and is preferably 180° C. or lower, more preferably 170° C. or lower, and still more preferably 160° C. or lower.

### <Plasticizer>

The hot-melt adhesive preferably further contains a plasticizer.

The plasticizer is not particularly limited, and a plasticizer used for the hot-melt adhesive is preferred, and oil or wax is more preferred. As the plasticizer, phthalates, adipates, fatty acid esters, glycols, epoxy-based polymer plasticizers, and the like can also be used.

Examples of the oil include paraffinic process oil, naphthenic process oil, isoparaffinic oil, and aromatic oil.

Examples of a commercial product of the paraffinic process oil include: “Diana Process Oil PW-32”, “Diana Process Oil PW-90”, and “Diana Process Oil PW-150”, “Diana Process Oil PS-32”, “Diana Process Oil PS-90”, “Diana Process Oil PS-430” (all trade names; “Diana” is a registered trademark) manufactured by Idemitsu Kosan Co., Ltd.; and “Kaydol (registered trademark) Oil” manufactured by Sonneborn LLC and “ParaLux (registered trademark) Oil” manufactured by Chevron USA Corporation (all trade names).

Examples of a commercial product of the isoparaffinic oil include: “IP Solvent 1016”, “IP Solvent 1620”, “IP Solvent 2028”, “IP Solvent 2835”, “IP Clean LX” manufactured by Idemitsu Kosan Co., Ltd.; and “NA Solvent” series manufactured by NOF Corporation (all trade names)

Examples of the wax include animal wax, vegetable wax, carnauba wax, candelilla wax, Japan wax, beeswax, mineral wax, petroleum wax, paraffin wax, microcrystalline wax, petrolatum, higher fatty acid wax, higher fatty acid ester wax, Fisher Tropsch wax, polypropylene wax, polyethylene wax, and propylene-ethylene copolymerized wax.

From viewpoints of improving the adhesion and the coatability, the content of the plasticizer in the hot-melt adhesive is preferably 2% by mass or more, more preferably 5% by mass or more, further more preferably 8% by mass or more, still further more preferably 10% by mass or more, and is preferably 60% by mass or less, more preferably 40% by mass or less, further more preferably 30% by mass or less, still further more preferably 20% by mass or less.

The total content of the modified hydrogenated petroleum resin, the base polymer, the tackifier, and the plasticizer in the hot-melt adhesive is preferably 70% by mass or more, more preferably 80% by mass or more, still more preferably 90% by mass or more, and is preferably 100% by mass or less.

### <Other Additives>

When necessary, the hot-melt adhesive may further contain any additive, such as an inorganic filler, an antioxidant, an ultraviolet absorber, a light stabilizer, and a glidant, within a range where the effects of the second invention are not impaired.

Examples of the inorganic filler include talc, calcium carbonate, barium carbonate, wollastonite, silica, clay, mica, kaolin, titanium oxide, diatomaceous earth, urea-based resin, styrene bead, starch, barium sulfate, calcium sulfate, magnesium silicate, magnesium carbonate, alumina, and quartz powder.

Examples of the antioxidant include a phosphorus-based antioxidant such as trisnonylphenyl phosphite, distearyl pentaerythritol diphosphite, “Adekastab (registered trademark) 1178” (manufactured by ADEKA Corporation), “SUMILIZER (registered trademark) TNP” (manufactured by Sumitomo Chemical Co., Ltd.), “Irgafos (registered trademark) 168” (manufactured by BASF SE), and “Sandstab (registered trademark) P-EPQ” (manufactured by Clariant AG), a phenol-based antioxidant such as 2,6-di-t-butyl-4-methylphenol, n-octadecyl-3-(3′,5′-di-t-butyl-4′-hydroxyphenyl) propionate, “Sumilyzer (registered trademark) BHT” (manufactured by Sumitomo Chemical Co., Ltd.), and “Irganox (registered trademark) 1010” (manufactured by BASF SE), and a sulfur-based antioxidant such as dilauryl-3,3′-thiodipropionate, pentaerythritol tetrakis(3-laurylthiopropionate), “Sumilyzer (registered trademark) TPL” (manufactured by Sumitomo Chemical Co., Ltd.), “DLTP ‘Yoshitomi (registered trademark)’”, “DSTP ‘Yoshitomi (registered trademark)’”, “DMTP ‘Yoshitomi (registered trademark)’” (all manufactured by Mitsubishi Chemical Corporation), and “Antiox (registered trademark) L” (manufactured by NOF Corporation).

### <Production Method and Application of Hot-Melt Adhesive>

The hot-melt adhesive may be produced by dry-blending the base polymer, the tackifier, the plasticizer, and the additive in addition to the modified hydrogenated petroleum resin by using a Henschel mixer or the like, if necessary, and melt-kneading the mixture with a single-screw or twin-screw extruder, a plastomill, a Banbury mixer, or the like.

The hot-melt adhesive has excellent heat resistance, is colorless and has a faint odor, and therefore, the hot-melt adhesive can be suitably used for, for example, interiors of transportation equipment such as automobiles, trains, ships, and aviation, sanitary materials, packaging, bookbinding, textiles, woodworking, electrical materials, can making, construction, filters, low pressure molding, and bag making.

Specifically, the hot-melt adhesive can be preferably used as an adhesive for hygiene products such as disposable diapers and sanitary products, and an adhesive for an assembly represented by an automobile floor mat and woodworking applications for kitchens. In particular, the hot-melt adhesive is preferably used as an adhesive for the automobile interiors and the hygiene products because the hot-melt adhesive has a faint odor.

### [Pressure-Sensitive Adhesive]

The pressure-sensitive adhesive according to one aspect of the second invention contains 1 to 70% by mass of the modified hydrogenated petroleum resin.

That is, the pressure-sensitive adhesive contains 1 to 70% by mass of a modified hydrogenated petroleum resin satisfying the following (A1) to (A4):
(A1) a bromine value of 0.1 to 10.0
(A2) containing 0.1 to 10% by mass of silicon element in terms of silicon atom
(A3) a weight average molecular weight of 500 to 5,000
(A4) a molecular weight distribution (Mw/Mn) of 1.1 to 3.5.

The modified hydrogenated petroleum resin is preferably used as a tackifier among components constituting a pressure-sensitive adhesive, and may be used in combination with a tackifier other than the modified hydrogenated petroleum resin. When used as any of the components of the modified hydrogenated petroleum resin, it is possible to improve the heat resistance of the obtained pressure-sensitive adhesive, and it is possible to obtain a colorless pressure-sensitive adhesive having a faint odor.

When the modified hydrogenated petroleum resin is used as a tackifier, the content of the modified hydrogenated petroleum resin is preferably 5% by mass or more, more preferably 10% by mass or more, further more preferably 20% by mass or more, still further more preferably 25% by mass or more, and is preferably 70% by mass or less, more preferably 60% by mass or less, further more preferably 40% by mass or less in the pressure-sensitive adhesive.

The pressure-sensitive adhesive contains an elastic body and a tackifier as main materials.

Examples of the elastic body include natural rubber, polyisoprene, butyl rubber, acrylic rubber, urethane rubber, silicone rubber, olefin-based elastomer, acrylic pressure-sensitive adhesive, and silicone-based pressure-sensitive adhesive. Examples of the olefin-based elastomer used as the elastic body include those that are the same as the olefin-based elastomer described in <Base Polymer> of the [Hot-melt Adhesive] section, and preferred embodiments thereof are also the same. Among them, an amorphous olefin polymer is preferable, and as the amorphous olefin polymer, an ethylene-propylene copolymer and an atactic polypropylene are preferable.

As the tackifier, a tackifier the same as the <Tackifier> of the [Hot-melt Adhesive] section is preferably used in addition to the modified hydrogenated petroleum resin.

The total content of the modified hydrogenated petroleum resin, the elastic body, and the tackifier in the pressure-sensitive adhesive is preferably 70% by mass or more, more preferably 80% by mass or more, still more preferably 90% by mass or more, and is preferably 100% by mass or less.

### [Asphalt Composition and Asphalt Mixture]

The asphalt composition according to one aspect of the second invention contains the modified hydrogenated petroleum resin and straight asphalt, and the content of the straight asphalt is preferably 70.00 to 99.99% by mass.

Examples of suitable straight asphalt, the content thereof, other components, and a production method include those that are the same as the asphalt composition described in [Asphalt Composition] section according to the first invention.

The asphalt mixture according to one aspect of the second invention contains the asphalt composition according to one aspect of the second invention and aggregate, and the content of the aggregate is preferably 80 to 99% by mass.

Examples of suitable aggregate, the content thereof, and a production method include those that are the same as the asphalt composition described in [Asphalt Mixture] section according to the first invention.

### [Third Invention]

Hereinafter, a modified hydrogenated petroleum resin (B), a method of producing the modified hydrogenated petroleum resin (B), and an adhesive composition containing the modified hydrogenated petroleum resin (B) will be described in order. In addition, an asphalt composition and an asphalt mixture will also be described.

### [Modified Hydrogenated Petroleum Resin (B)]

A modified hydrogenated petroleum resin according to one aspect of the third invention is a modified hydrogenated petroleum resin (B) obtained by subjecting a modified hydrogenated petroleum resin (A) satisfying the following (A1) to (A4) to a condensation reaction, wherein the modified hydrogenated petroleum resin (B) satisfies the following (B1) to (B3):
(A1) a bromine value of 0.1 to 10.0
(A2) containing 0.1 to 10% by mass of silicon element in terms of silicon atom
(A3) a weight average molecular weight of 500 to 5,000
(A4) a molecular weight distribution (Mw/Mn) of 1.1 to 3.5
(B1) a viscosity V0.1 measured using a rheometer at 190° C. with an angular velocity ω=0.1 rad/s of 1,000 to 50,000 mPa·s
(B2) a viscosity V100 measured using a rheometer at 190° C. with an angular velocity ω=100 rad/s of 100 to 1,000 mPa·s
(B3) a ratio of the viscosity V0.1 to the viscosity V100 [V0.1/V100] of 10 or more.

### <Characteristics of Modified Hydrogenated Petroleum Resin (B)>

The modified hydrogenated petroleum resin (B) according to one aspect of the third invention has a viscosity V0.1 (hereinafter simply referred to as “V0.1”) measured using a rheometer at 190° C. with an angular velocity ω=0.1 rad/s of 1,000 to 50,000 mPa·s (the requirement (B1)). When V0.1 of the modified hydrogenated petroleum resin (B) satisfies the above range, the cohesive force of the adhesive composition containing the modified hydrogenated petroleum resin (B) is increased, and the adhesive strength is excellent. The V0.1 of the modified hydrogenated petroleum resin (B) is preferably 2,000 to 45,000 mPa·s, more preferably 3,000 to 40,000 mPa·s, still more preferably 4,000 to 38,000 mPa·s.

Further, the modified hydrogenated petroleum resin (B) has a viscosity V100 (hereinafter simply referred to as “V100”) measured using a rheometer at 190° C. with an angular velocity ω=100 rad/s of 100 to 1,000 mPas (the requirement (B2)). When V100 of the modified hydrogenated petroleum resin (B) satisfies the above range, the coatability of the adhesive composition containing the modified hydrogenated petroleum resin (B) becomes good. The V100 of the modified hydrogenated petroleum resin (B) is preferably 200 to 800 mPa·s, more preferably 250 to 600 mPa·s, still more preferably 300 to 400 mPa·s.

The V0.1 and V100 of the modified hydrogenated petroleum resin (B) can be specifically measured by a method described in Examples.

In addition, the ratio of the viscosity V0.1 to the viscosity V100 [V0.1/V100] (hereinafter simply referred to as “[V0.1/V100]”) of the modified hydrogenated petroleum resin (B) is 10 or more (the requirement (B3)). When the [V0.1/V100] of the modified hydrogenated petroleum resin (B) satisfies the above range, the adhesive composition containing the modified hydrogenated petroleum resin (B) has both good coatability and high adhesive strength.

The [V0.1/V100] of the modified hydrogenated petroleum resin (B) is preferably 11 or more, more preferably 30 or more, further more preferably 35 or more, still further more preferably 40 or more. Moreover, the upper limit thereof is preferably 1,000 or less, more preferably 800 or less, further more preferably 500 or less, and still further more preferably 300 or less.

The [V0.1/V100] of the modified hydrogenated petroleum resin (B) can be calculated from the value of V0.1 and the value of V100 of the modified hydrogenated petroleum resin (B) specifically measured by a method described in Examples.

### <Modified Hydrogenated Petroleum Resin (A)>

The modified hydrogenated petroleum resin (B) is obtained by subjecting a modified hydrogenated petroleum resin (A) to a condensation reaction. The modified hydrogenated petroleum resin (A) has the same meaning as the [Modified Hydrogenated Petroleum Resin] described in the second invention. Since preferred embodiments thereof are also the same, the description thereof is omitted here.

Examples of the condensation reaction include, when the modified hydrogenated petroleum resin (A) has a functional group capable of a condensation reaction, the modified hydrogenated petroleum resin (A) reacts via the functional group. The condensation reaction includes a case where functional groups existing in one molecule of the modified hydrogenated petroleum resin (A) undergo a condensation reaction in the molecule, and a case where the modified hydrogenated petroleum resin (A) of two or more molecules undergoes a condensation reaction between the molecules via the functional group. Of these, the condensation reaction between molecules is preferable. For example, when the modified hydrogenated petroleum resin (A) has an alkoxysilyl group or the like, the alkoxysilyl group or the like is hydrolyzed by water or the like to generate silanol groups, and the generated silanol groups undergo a condensation reaction with each other. Further, it is conceivable that the hydroxy group or the like and the silanol group undergo a condensation reaction when the modified hydrogenated petroleum resin (A) contains a substituent capable of undergoing a condensation reaction with a silanol group such as a hydroxy group.

### [Production Method of Modified Hydrogenated Petroleum Resin (B)]

A method of producing the modified hydrogenated petroleum resin (B) includes at least the following step (a):
step (a): a step of subjecting the modified hydrogenated petroleum resin (A) satisfying the following (A1) to (A4) to a condensation reaction:
(A1) a bromine value of 0.1 to 10.0
(A2) containing 0.1 to 10% by mass of silicon element in terms of silicon atom
(A3) a weight average molecular weight of 500 to 5,000
(A4) a molecular weight distribution (Mw/Mn) of 1.1 to 3.5.

As described above, the modified hydrogenated petroleum resin (A) has the same meaning as the modified hydrogenated petroleum resin described in the second invention. Since preferred embodiments thereof are also the same, the description thereof is omitted here.

In the condensation reaction of the step (a), it is preferable that the modified hydrogenated petroleum resin (A) has an alkoxysilyl group, and a silanol group produced by hydrolyzing the alkoxysilyl group is subjected to a condensation reaction.

Therefore, it is preferable that water is present in order to carry out the step (a). The water may be added during the step (a), or may be water present in the air.

Further, a catalyst may be used to carry out the condensation reaction in the step (a).

Examples of the catalyst include an acid catalyst, a base catalyst, and a metal catalyst. Among these, an acid catalyst and a metal catalyst are preferable, and a metal catalyst is more preferable.

Examples of the acid catalyst include nitric acid, hydrochloric acid, sulfuric acid, oxalic acid, malonic acid, phosphoric acid, acetic acid, trifluoroacetic acid, methanesulfonic acid, benzenesulfonic acid and p-toluenesulfonic acid.

Examples of the base catalyst include sodium hydroxide, potassium hydroxide, lithium hydroxide, dimethylamine, dimethylamine, trimethylamine, tetramethylammonium hydroxide, ethylamine, triethylamine, diethylamine and ethylamine.

Examples of the metal catalyst include dibutyltin diacetate, bis(acetoxydibutyltin)oxide, bis(lauroxydibutyltin)oxide, dibutyltin bisacetylacetonate, dibutyltin bismaleic acid monobutyl ester, dioctylbismaleic acid monobutyl ester, dibutyltin dilaurate, diisopropoxytitanium bis(acetylacetonate), titaniumtetra(acetylacetonate), dioctanoxititanium dioctanate, and diisopropoxytitanium bis(ethylacetate acetate).

The catalyst may be used alone or in combination of two or more.

The temperature of the step (a) is not particularly limited, but is preferably 0 to 200° C., more preferably 10 to 150° C., and even more preferably 20 to 100° C.

Further, the step (a) may be carried out when producing an adhesive composition (C) containing the modified hydrogenated petroleum resin (B) described later. For example, the condensation reaction of the modified hydrogenated petroleum resin (A) may be carried out when the modified hydrogenated petroleum resin (A) is added and the modified hydrogenated petroleum resin (A) is mixed with other components such as a base polymer described later.

### [Adhesive Composition (C)]

The adhesive composition (C) according to one aspect of the third invention is an adhesive composition (C) including the modified hydrogenated petroleum resin (B) and satisfying the following (C1) to (C3):
(C1) a viscosity V0.1 measured using a rheometer at 190° C. with an angular velocity ω=0.1 rad/s of 20,000 to 800,000 mPa·s
(C2) a viscosity V100 measured using a rheometer at 190° C. with an angular velocity ω=100 rad/s of 1,000 to 5,000 mPa·s
(C3) a ratio of the viscosity V0.1 to the viscosity V100 [V0.1/V100] of 10 or more.

The adhesive composition (C) has a viscosity V0.1 measured using a rheometer at 190° C. with an angular velocity ω=0.1 rad/s of 20,000 to 800,000 mPa·s (the requirement (C1)). When V0.1 of the adhesive composition (C) satisfies the above range, the cohesive force of the adhesive composition (C) is increased, and the adhesive strength is excellent. The V0.1 of the adhesive composition (C) is preferably 39,000 to 700,000 mPa·s, more preferably 200,000 to 650,000 mPa·s, still more preferably 250,000 to 300,000 mPa·s.

Further, the adhesive composition (C) has a viscosity V100 measured using a rheometer at 190° C. with an angular velocity ω=100 rad/s of 1,000 to 5,000 mPa·s (the requirement (C2)). When V100 of the adhesive composition (C) satisfies the above range, the coatability of the adhesive composition (C) becomes good. The V100 of the adhesive composition (C) is preferably 1,000 to 4,500 mPa·s, more preferably 1,500 to 4,000 mPas, still more preferably 2,000 to 3,500 mPa·s.

The V0.1 and V100 of the adhesive composition (C) can be specifically measured by a method described in Examples.

In addition, the ratio of the viscosity V0.1 to the viscosity V100 [V0.1/V100] of the adhesive composition (C) is 10 or more (the requirement (C3)). When the [V0.1/V100] of the adhesive composition (C) satisfies the above range, the adhesive composition (C) has both good coatability and high adhesive strength.

The [V0.1/V100] of the adhesive composition (C) is preferably 15 or more, more preferably 50 or more, further more preferably 150 or more. Moreover, the upper limit thereof is preferably 1,000 or less, more preferably 500 or less, further more preferably 250 or less.

The [V0.1/V100] of the adhesive composition (C) can be calculated from the value of V0.1 and the value of V100 of the adhesive composition (C) specifically measured by a method described in Examples.

By containing the modified hydrogenated petroleum resin (B), the adhesive composition (C) becomes an adhesive composition satisfying the above requirements (C1) to (C3), and can have both good coatability and high adhesive strength.

From the viewpoint of facilitating the acquisition of an adhesive composition satisfying the requirements (C1) to (C3), the content of the modified hydrogenated petroleum resin (B) in the adhesive composition is preferably 1% by mass or more, more preferably 5% by mass or more, further more preferably 10% by mass or more, still more preferably 20% by mass or more, even still more preferably 25% by mass or more, and is preferably 70% by mass or less, more preferably 60% by mass or less, further more preferably 55% by mass or less.

The adhesive composition (C) may contain a base polymer in addition to the modified hydrogenated petroleum resin (B), and may further contain one or more selected from a plasticizer, a tackifier, and other additives.

### <Base Polymer>

The adhesive composition (C) preferably contains a base polymer in addition to the modified hydrogenated petroleum resin (B).

As used herein, the “base polymer” according to the third invention refers to a polymer contained most in polymer components used as components other than the modified hydrogenated petroleum resin (B).

Specific examples of the base polymer include natural rubber, polyisoprene, butyl rubber, acrylic rubber, urethane rubber, silicone rubber, an olefin-based elastomer, a styrene-based elastomer, and an olefin-based plastomer. In addition, examples of the base polymer used in a reactive hot-melt adhesive include polymers having a silane-containing group and an isocyanate group that undergo a condensation reaction with water.

Among these, when the adhesive composition (C) is used as a hot-melt adhesive, natural rubber, an olefin-based elastomer, a styrene-based elastomer, and an olefin-based plastomer are preferable, and an olefin-based elastomer and a styrene-based elastomer are more preferable.

Further, when the adhesive composition (C) is used as a pressure-sensitive adhesive, natural rubber, polyisoprene, butyl rubber, acrylic rubber, urethane rubber, silicone rubber, and an olefin elastomer are preferable, and natural rubber, polyisoprene, butyl rubber, acrylic rubber, urethane rubber and an olefin-based elastomer are more preferable.

In addition, when the adhesive composition (C) is used as a pressure-sensitive adhesive, an acrylic adhesive or a silicone-based adhesive may be used instead of the base polymer.

These base polymers may be used alone or in combination of two or more.

Examples of the olefin-based elastomer include the same as the olefin-based elastomer described in <Base Polymer> of the [Hot-melt Adhesive] according to the second invention, and the preferred embodiments thereof are also the same. When the adhesive composition (C) is used as a pressure-sensitive adhesive, the olefin-based elastomer is preferably an amorphous olefin polymer among them, and as the amorphous olefin polymer, an ethylene-propylene copolymer and an atactic polypropylene are preferable.

Examples of the styrene-based elastomer include the same styrene-based elastomers described in <Base Polymer> of the [Hot-melt Adhesive] according to the second invention, and the preferred embodiments thereof are also the same.

From a viewpoint of cohesion, the content of the base polymer in the adhesive composition (C) is preferably 5% by mass or more, more preferably 10% by mass or more, still more preferably 20% by mass or more, and yet still more preferably 30% by mass or more, and is preferably 90% by mass or less, more preferably 80% by mass or less, still more preferably 70% by mass or less, further more preferably 60% by mass or less, and yet still more preferably 50% by mass or less.

### <Plasticizer>

The adhesive composition (C) preferably further contains a plasticizer.

The plasticizer is not particularly limited, and examples thereof include the same plasticizers described in <Plasticizer> of the [Hot-melt Adhesive] according to the second invention, and the preferred embodiments thereof are also the same.

From viewpoints of improving the adhesion and the coatability, the content of the plasticizer in the adhesive composition (C) is preferably 2% by mass or more, more preferably 5% by mass or more, further more preferably 8% by mass or more, still further more preferably 10% by mass or more, and is preferably 60% by mass or less, more preferably 40% by mass or less, further more preferably 30% by mass or less, still further more preferably 20% by mass or less.

### <Tackifier>

The adhesive composition (C) preferably further contains a tackifier.

Examples of the tackifier include the same tackifiers described in <Tackifier> of the [Hot-melt Adhesive] according to the second invention, and the preferred embodiments thereof are also the same.

In addition, the adhesive composition (C) may further contain a modified hydrogenated petroleum resin (A) as a tackifier, within a range where the effects of the third invention are not impaired.

From the viewpoint of improving the adhesion, the content of the tackifier in the adhesive composition (C) is preferably 5% by mass or more, more preferably 10% by mass or more, still more preferably 20% by mass or more, and yet still more preferably 30% by mass or more, and is preferably 80% by mass or less, more preferably 70% by mass or less, still more preferably 60% by mass or less, and yet still more preferably 50% by mass or less.

The total content of the modified hydrogenated petroleum resin (B), the base polymer, the plasticizer, and the tackifier in the adhesive composition (C) is preferably 70% by mass or more, more preferably 80% by mass or more, still more preferably 90% by mass or more, and is preferably 100% by mass or less.

### <Other Additives>

When necessary, the adhesive composition (C) may further contain any additive, such as an inorganic filler, an antioxidant, an ultraviolet absorber, a light stabilizer, and a glidant, within a range where the effects of the third invention are not impaired.

Examples of the inorganic filler include the same as the inorganic fillers described in <Other Additives> of the [Hot-melt Adhesive] according to the second invention.

Examples of the antioxidant include the same antioxidants described in <Other Additives> of the [Hot-melt Adhesive] according to the second invention.

### <Production Method and Application of Adhesive Composition (C)>

The adhesive composition (C) may be produced by dry-blending the base polymer, the plasticizer, the tackifier, and other additives in addition to the modified hydrogenated petroleum resin (B) by using a Henschel mixer or the like, if necessary, and melt-kneading the mixture with a single-screw or twin-screw extruder, a plastomill, a Banbury mixer, or the like.

Further, the adhesive composition (C) can also be produced by subjecting the modified hydrogenated petroleum resin (A) to a condensation reaction while melt-kneading, in addition to the modified hydrogenated petroleum resin (A) which is a raw material of the modified hydrogenated petroleum resin (B), as necessary, a base polymer, a plasticizer, a tackifier and other additives using the aforementioned method to generate the modified hydrogenated petroleum resin (B). As a method for subjecting the modified hydrogenated petroleum resin (A) to a condensation reaction, the method described above for the step (a) can be used.

Since the adhesive composition (C) can achieve both good coatability and high adhesive strength, it can be used, for example, as an adhesive such as a hot-melt adhesive and a pressure-sensitive adhesive.

Further, the adhesive composition (C) contains the modified hydrogenated petroleum resin (B), and as described above, the modified hydrogenated petroleum resin (B) is obtained by subjecting the modified hydrogenated petroleum resin (A) described in the second invention to a condensation reaction. Therefore, the adhesive composition (C) containing the modified hydrogenated petroleum resin (B) also has excellent heat resistance, is colorless and has a faint odor like the adhesive composition containing the modified hydrogenated petroleum resin (A) in the second invention.

Therefore, the adhesive composition can be suitably used for, for example, interiors of transportation equipment such as automobiles, trains, ships, and aviation, sanitary materials, packaging, bookbinding, textiles, woodworking, electrical materials, can making, construction, filters, low pressure molding, and bag making.

Specifically, the adhesive composition can be preferably used as an adhesive for hygiene products such as disposable diapers and sanitary products, and an adhesive for an assembly represented by an automobile floor mat and woodworking applications for kitchens. In particular, the adhesive composition is preferably used as an adhesive for the automobile interiors and the hygiene products because the hot-melt adhesive has a faint odor.

### [Asphalt Composition and Asphalt Mixture]

The asphalt composition according to one aspect of the third invention contains the modified hydrogenated petroleum resin (B) and straight asphalt, and the content of the straight asphalt is preferably 70.00 to 99.99% by mass.

Examples of suitable straight asphalt, the content thereof, other components, and a production method include those that are the same as the asphalt composition described in [Asphalt Composition] section according to the first invention.

The asphalt mixture according to one aspect of the third invention contains the asphalt composition according to one aspect of the third invention and aggregate, and the content of the aggregate is preferably 80 to 99% by mass.

Examples of suitable aggregate, the content thereof, and a production method include those that are the same as the asphalt composition described in [Asphalt Mixture] section according to the first invention.

### EXAMPLES

Next, the first invention, the second invention, and the third invention according to the present invention will be described in more details with examples. However, the first invention, the second invention and the third invention according to the present invention are not limited to these examples.

### [Analysis and Evaluation of Silane Compound and Modified Hydrogenated Petroleum Resin]

### [1. Bromine Value]

It was measured according to JIS K 2605.

### [2. Silicon Element Concentration]

0.1 g of modified hydrogenated petroleum resins, modified petroleum resins, or hydrogenated petroleum resins obtained in Examples and Comparative Examples were heated at 550° C. for 12 hours in an electric furnace, a solution for measurement was prepared by alkaline melting of ash, and ICP emission spectroscopic analysis was performed (ICP emission spectroscopic analyzer: 720-ES, manufactured by Agilent Technologies, Inc.) to determine the concentration of silicon element.

### [3. Molecular Weight and Molecular Weight Distribution]

The average molecular weight was measured by gel permeation chromatography (GPC). For the measurement, a GPC measuring device (HLC8220, detector: RI, column: TSK-GEL GHXL-L, G4000HXL, G2000HXL, and tetrahydrofuran was used as an eluent. All were manufactured by Toso Co., Ltd.) was used to obtain a polystyrene-equivalent number average molecular weight (Mn) and a weight average molecular weight (Mw), and the molecular weight distribution (Mw/Mn) was calculated.

### [4. Integral Ratio of Aromatic Hydrogen]

Resins after the silane modification treatments obtained in Examples and Comparative Examples were subjected to ¹H-NMR measurement using a nuclear magnetic resonance (NMR) device (JNM-EX400, manufactured by JEOL Ltd.) under conditions of deuterated chloroform as a solvent and the number of integration times of 256, to obtain a ratio of an integral value of peak in 6.5 to 7.5 ppm (peak of aromatic hydrogen) to a sum of an integral value of peak in 0 to 3.0 ppm region and an integral value of peak in 6.5 to 7.5 ppm region [integral value of peak in 6.5 to 7.5 ppm region/(sum of integral value of peak in 0 to 3.0 ppm region and integral value of peak in 6.5 to 7.5 ppm region)]. At that time, when there was a peak caused by an additive (antioxidant, etc.) or a solvent (chloroform, etc.) of the raw material in the 0 to 3.0 ppm region and the 6.5 to 7.5 ppm region, it was obtained by measuring reference materials in the same manner and then subtracting the integral values thereof from the aforementioned integral values. However, regarding the hydrogenated petroleum resins that had not been subjected to the silane modification treatment, the resins of Comparative Examples 2-2 to 2-4 were measured in the same manner to obtain the above integral ratio.

### [5. Softening Point]

It was measured according to JIS K 6863.

### [6. Volatile Component Content]

A headspace gas chromatograph (device name: Agilent 7697A/Agilent 7890B) was used to cause a gas component to generate and perform measurement under the following conditions, and during the measurement, an amount of the component having a retention time of less than 40 minutes was regarded as a volatile component content.

Measurement conditions: sample heat treatment: 150° C., 20 minutes, column: BPX5 30 m×0.32 m i.d.×1.0 μm, inlet: 300° C., temperature program: 50° C. to 300° C., temperature rise: 10° C./min

### [7. Glass Transition Temperature]

It is obtained from a melting endothermic curve obtained under the following measurement conditions. Specifically, an intersection of tangents at a low temperature side baseline with no change in calorific value and an inflection point (a point where an upwardly convex curve changes to a downwardly convex curve) or a midpoint of a displacement is defined as a glass transition point (Tg).

### <Measurement Conditions>

A differential scanning calorimeter (DSC) (manufactured by Perkin Elmer, “DSC-7”) was used, and 10 mg of a sample was held at 25° C. for 5 minutes in a nitrogen atmosphere and was then held for 5 minutes after the temperature was raised to 220° C. at 320° C./min. After cooling to −20° C. at 320° C./min and holding the sample at −20° C. for 5 minutes, the temperature is raised to 220° C. at 10° C./min to obtain a melting endothermic curve.

### [8. Integral Ratio of Tertiary Carbon]

¹³C-NMR spectrum was measured with the following apparatus and conditions, and was calculated by the following formula.
Apparatus: AVANCE III HD manufactured by Bruker Biospin Co., Ltd.
Probe: BBO 10 mmo sample tube compatible
Method: Proton complete decoupling method
Sample tube diameter: 10 mmq
Sample concentration: 220 mg/mL
Solvent: Deuterated chloroform
Observation range: −20 to 220 ppm
Observation center: 100 ppm
Temperature: Room temperature
Pulse width: 45°
Pulse repetition time: 4 seconds
Integration: 1000 times

### <Calculation Formula>

$$Integral ratio of tertiary carbon ( \% ) = A / B \times 100$$

A: Integral value of peak in 35 to 64 ppm region (integral value of aliphatic tertiary carbon)
B: Integral value of peak in 10 to 64 ppm region (integral value of total aliphatic carbon)
   [9. Ratio of Absorbance (ASiO) Derived from Silicon-oxygen Bond and Absorbance (ACH) Derived from Carbon-hydrogen Bond (ASiO/ACH)]

60 mg of a silane compound was dissolved in 4 mL of dichloromethane, and 10 μL of the mixture was added dropwise onto a KBr plate. After placing the KBr plate on a hot plate at 40° C. and drying for 3 minutes, FT-IR was measured under the following conditions, and from the obtained absorbance, a ratio of absorbance (ASiO) derived from a silicon-oxygen bond and absorbance (ACH) derived from a carbon-hydrogen bond (ASiO/ACH) was calculated.

The absorbance (ASiO) derived from the silicon-oxygen bond is the absorbance around 1091 cm⁻¹ when 1040 cm⁻¹ to 1160 cm⁻¹ is used as a baseline, and the absorbance (ACH) derived from the carbon-hydrogen bond is the absorbance around 2925 cm⁻¹ when 2750 cm⁻¹ to 3110 cm⁻¹ is used as a baseline.

Apparatus: Fourier Transform Infrared Spectroscopy Analyzer Spectrum One (manufactured by Perkin Elmer)
Measurement method: Permeation method
Observation range: 450 to 4000 cm⁻¹
Resolution: 4.00 cm⁻¹
Integration times: 4 times

### [10. Viscosity at 40° C.]

A viscosity (B-type viscosity) was measured at 40° C. using a Brookfield type rotational viscometer according to ASTM D 3236.

### [11. Odor]

1.0 g of the modified hydrogenated petroleum resins, the modified petroleum resins, or the hydrogenated petroleum resins obtained in Examples and Comparative Examples were placed in a glass sample bottle having a volume of 20 mL, sealed tightly, left at 25° C. for 1 hour, then opened and subjected to a sensory evaluation. It was evaluated according to the following criteria. The fainter odor, the better.
1. Odorless
2. Almost no odor
3. Has a weak odor
4. Has a strong odor

### [12. Colorlessness]

It was measured according to JIS K 0071-2.

### [13. Temperature Rising Creep Test (Evaluation of Heat Resistance)]

### <Preparation of Test Piece>

A resin composition (adhesive) obtained in Examples and Comparative Examples was applied onto a Teflon (registered trademark) sheet heated to 140° C. to make a film (size 60 mm×30 mm, thickness of 0.1 mm) of the resin composition. The film of the resin composition was placed on a cotton canvas (fabric thickness: 13.0 ounces), a piece of wood (contact surface with the resin composition: lauan material) was placed on the film, and a weight of 500 g was further placed thereon and heated at 150° C. for 1 minute (adhesive surface was 60 mm×30 mm).

After cooling, a test piece was prepared by leaving it for 10 days in an environment of 23° C. and 50% humidity.

### <Temperature Rising Creep Test (Shear Adhesion Failure Temperature)>

In an environment of 30° C. and 30% humidity, an end of the wood piece portion of the test piece was fixed, and a load of 200 g was applied to the cotton canvas in a shearing direction (parallel to an adhesive surface and opposite to the wood piece fixing part) (the adhesive surface between the cotton canvas and the resin composition and the adhesive surface between the resin composition and the wood piece are 18 cm² each). The temperature was raised from 30° C. at a speed of 0.5° C./min, and a temperature at which the cotton canvas of the test piece was peeled off was measured and used as the creep temperature of the resin composition.

The higher the creep temperature, the more excellent the heat resistance.

### [14. Viscosity (Measurement of V0.1 and V100)]

By press molding, a disk-shaped test piece having a diameter of 25 mm and a thickness of 1 mm was produced. Dynamic viscoelasticity was measured by a parallel plate method (φ=25 mm, gap 1 mm) using Rheometer MCR301 manufactured by Anton Paar GmbH under the conditions of a strain of 5%, a nitrogen atmosphere, a temperature of 190° C., and a shear rate of 100 s⁻¹ to 0.1 s⁻¹. From the measurement results, the viscosity (V0.1) when the shear rate was 0.1 s⁻¹ and the viscosity (V100) when the shear rate was 100 s⁻¹ were obtained. Further, from the results, the ratio [V0.1/V100] of the viscosity V0.1 to the viscosity V100 was calculated.

### [Evaluation of Asphalt Composition]

### [Water Resistance (Peeling Resistance)]

Water resistance was evaluated using a specimen (asphalt mixture) obtained by mixing an asphalt composition and a hard sandstone aggregate of 9.5 mm or more and 13.2 mm or less by the procedure shown below.

The specimen was produced by adding 5.5 g±0.5 g of each asphalt composition heated at 180° C. for 1 hour to 100 g±0.5 g of the hard sandstone aggregate washed with water and dried, and stirring for about 1 minute. Next, 10 specimens were selected from the prepared specimens, and the selected specimens were put into 100 mL of a 1.0 (mol/L) sodium carbonate aqueous solution. Then, the specimen was heated on a hot plate, heated for 1 minute after reaching 90° C., cooled, and then a peeling area rate of the specimen was measured.

The peeling area rate of an upper surface of the specimen and the peeling area rate of a lower surface of the specimen were measured, and an average peeling rate of the upper and lower surfaces was calculated by averaging the measured peeling area rate of the upper surface and the measured peeling area rate of the lower surface of the specimen to determine the peeling resistance.

The lower the average peeling rate of the upper and lower surfaces, the more excellent the peeling resistance and water resistance, and the evaluation was made according to the following evaluation criteria.
A: The average peeling rate of the upper and lower surfaces is less than 40%
B: The average peeling rate of the upper and lower surfaces is 40% or more

### [Production of Organic Compound Having Cyclic Structure]

### Production Example 1-1 (Production of Petroleum Resin (Unhydrogenated)

180 g of xylene was put into a 1-liter autoclave and the temperature was raised to 260° C. Next, a mixture of 100 g of dicyclopentadiene and 100 g of styrene was added over 3 hours. The temperature was maintained for another 75 minutes, and a polymerization reaction was carried out to obtain a polymer mixture.

Thereafter, xylene was recovered from the obtained polymer mixture and then maintained at 20 mmHg for 2 hours to distill off a low boiling point product to obtain a petroleum resin having a cyclic structure represented by the aforementioned formula (4). The obtained petroleum resin had a softening point of 63.0° C. and a bromine value of 58.

### Production Example 1-2 (Production of 9-allyl anthracene)

Flake-shaped magnesium (2.7 g, 110 mmol) was placed in a 300 mL three-necked round-bottom flask equipped with a nitrogen introduction tube and a Dimroth tube, and stirred at about 100° C. for 10 minutes to activate the surface of magnesium. Thereafter, dry tetrahydrofuran (30 mL) was added, and then a tetrahydrofuran solution (50 mL) of 9-bromo-anthracene (8.7 g, 55 mmol) was added dropwise, and the mixture was slowly refluxed. After 1 hour, a tetrahydrofuran solution (50 mL) of allyl bromide (6.7 g, 55 mmol) was added dropwise in an ice bath. After completion of the dropping, the ice bath was removed, and the mixture was stirred at room temperature for 8 hours. Tetrahydrofuran was distilled off under reduced pressure in an amount of about 50 mL, n-heptane (300 mL) was added, and the mixture was filtered to separate into a liquid phase and a solid content. The liquid phase was passed through a silica gel column, and 300 mL of n-heptane was passed through the column to obtain a solution. The liquid phase was distilled off under reduced pressure to obtain 9-allyl anthracene (5.1 g).

### [Production of Silane Compound]

### Example 1-1 (Production of Silane-modified Petroleum Resin (Unhydrogenated))

50 g of the petroleum resin obtained in Production Example 1-1 and dehydrated toluene (50 mL) were put into a glass container (300 mL) equipped with a nitrogen introduction tube and a stirring blade, and dissolved by stirring at 60° C. Then, under a nitrogen atmosphere, trimethoxysilane (1 g) and platinum (0)-1,3-divinyl-1,1,3,3-tetramethyldisiloxane complex solution (0.1 M, 0.1 mL) were added, and the mixture was stirred at 60° C. for 3 hours. After completion of the reaction, a silane compound P, which is a silane-modified petroleum resin (unhydrogenated) having a cyclic structure represented by the formula (4), was obtained by air-drying on a tray and then drying at 110° C. for 2 hours under reduced pressure. Table 1 shows the analysis and evaluation results of the obtained silane compound P.

### Example 1-2 (Production of Silane-modified Petroleum Resin (Unhydrogenated))

A silane compound Q, which is a silane-modified petroleum resin (unhydrogenated) having a cyclic structure represented by the formula (4), was obtained in the same manner as in Example 1-1 except that Escorez 1310 (manufactured by Exxon) was used instead of the petroleum resin obtained in Production Example 1-1. Table 1 shows the analysis and evaluation results of the obtained silane compound Q.

### Example 1-3 (Production of Silane-modified Anthracene Compound)

5.1 g (23.3 mmol) of the 9-allylanthracene obtained in Production Example 1-2 and 50 mL of dry toluene were placed into a 300 mL three-necked round-bottom flask equipped with a nitrogen introduction tube, and 2.9 g of trimethoxysilane and platinum (0)-1,3-divinyl-1,1,3,3-tetramethyldisiloxane complex solution (0.1 M, 0.1 mL) were added under nitrogen. After stirring for 3 hours, the solvent was distilled off under reduced pressure to obtain a silane compound S, which is a silane-modified anthracene compound having a cyclic structure represented by the formula (5). Table 1 shows the analysis and evaluation results of the obtained silane compound S.

### Example 1-4 (Production of Silane-modified Microcrystalline Wax)

100 g of microcrystalline wax Hi-Mic-1080 (manufactured by Nippon Seiro Co., Ltd.) was placed in a 300 mL three-necked round-bottomed flask equipped with a nitrogen introduction tube, and heated to 160° C. to melt in an oil bath under a nitrogen atmosphere. Then, 2.0 g of trimethoxysilane and 1.0 g of an organic peroxide (2,5-dimethyl-2,5-di(t-butylperoxy)hexane, trade name “PERHEXA (registered trademark) 25B”, manufactured by NOF Corporation) were added under nitrogen. After stirring for 1 hour, the volatile components were distilled off under reduced pressure to obtain a silane compound T, which is a silane-modified microcrystalline wax having a cyclic structure represented by the formulae (1), (2) and (3). Table 1 shows the analysis and evaluation results of the obtained silane compound T.

TABLE 1

| | Example1-1 | Example1-2 | Example1-3 | Example1-4 |
|---|---|---|---|---|
| Silane | P | Q | S | T |
| compound | Silane- | Silane- | Silane- | Silane- |
| | modified | modified | modified | modified |
| | petroleum | petroleum | anthracene | micro- |
| | rein | resin | compound | crystalline |
| | (unhydro- | (unhydro- | | wax |
| | genated) | genated) | | |
| Cyclic structure | Formula (4) | Formula (4) | Formula (5) | Formulae |
| | | | | (1), (2), (3) |
| Bromine value | 67 | 125 | — | — |
| (g/100 g) | | | | |
| Silicon element | 0.3 | 0.3 | 6.5 | 0.4 |
| concentration | | | | |
| (%) | | | | |
| Weight average | 1,250 | 1,300 | — | — |
| molecular | | | | |
| weight (Mw) | | | | |
| Molecular | 2.1 | 2.2 | — | — |
| weight | | | | |
| distribution | | | | |
| (Mw/Mn) | | | | |
| Softening point | 91 | 93.5 | — | — |
| (° C.) | | | | |
| Volatile | 0.5 | 0.4 | — | — |
| component (%) | | | | |
| Glass transition | 42.5 | 51.3 | — | — |
| temperature | | | | |
| (° C.) | | | | |
| Integral ratio of | 31.9 | 16.7 | 59.0 | 12.8 |
| aromatic | | | | |
| hydrogen (%) | | | | |
| Integral ratio of | 70.0 | 65.0 | — | 2.3 |
| tertiary carbon | | | | |
| ASiO/ACH | 0.06 | 0.06 | 4.17 | 0.04 |
| (IR) | | | | |
| Viscosity (° C.) | — | — | — | — |
| Odor | 4 | 4 | — | — |
| Colorlessness | 15 | 15 | — | — |
| (Gardner color | | | | |
| scale) | | | | |

### [Production of Petroleum Resin and Hydrogenated Petroleum Resin]

### Production Example 2-1 (Production of Petroleum Resin)

180 g of xylene was put into a 1-liter autoclave and the temperature was raised to 260° C. Next, a mixture of 100 g of dicyclopentadiene and 100 g of styrene was added over 3 hours. The temperature was maintained for another 75 minutes, and a polymerization reaction was carried out to obtain a polymer mixture.

Thereafter, xylene was recovered from the obtained polymer mixture and then maintained at 20 mmHg for 2 hours to distill off a low boiling point product to obtain a petroleum resin. The obtained petroleum resin had a softening point of 63.0° C. and a bromine value of 58.

### Production Example 2-2 (Production of Hydrogenated Petroleum Resin)

180 g of the petroleum resin obtained in Production Example 2-1, 180 g of ethylcyclohexane, and 4 g of a nickel-based catalyst (N110 series) manufactured by JGC Catalysts and Chemicals Ltd. were put into a 1-liter autoclave. Hydrogen was added such that a hydrogen pressure became 5 MPa, and the temperature was raised from room temperature to 230° C. Then, a hydrogenation reaction was carried out for 8 hours while keeping the hydrogen pressure at 5 MPa to obtain a hydrogenated petroleum resin. The obtained hydrogenated petroleum resin had a softening point of 100° C. and a bromine value of 2.5. This is referred to as hydrogenated petroleum resin E.

### [Production of Modified Petroleum Resin and Modified Hydrogenated Petroleum Resin]

### Example 2-1

110 g of the hydrogenated petroleum resin E obtained in Production Example 2-2 was placed in a 500 mL separable flask equipped with a nitrogen introduction tube and a stirring blade, and heated to 140° C. in an oil bath under a nitrogen gas stream.

When the hydrogenated petroleum resin was dissolved, 12 g of vinyltrimethoxysilane (manufactured by Tokyo Chemical Industry Co., Ltd.) was added while stirring, and the mixture was stirred until homogeneous.

Then, 0.5 g of an organic peroxide (2,5-dimethyl-2,5-di(t-butylperoxy)hexane, trade name “PERHEXA (registered trademark) 25B”, manufactured by NOF Corporation) were added dropwise. After the dropping, the mixture was stirred at an internal temperature (reaction mixture temperature) of 145° C. for 1 hour and reacted.

After completion of the reaction, the contents of the flask were taken out to a stainless steel tray and dried under vacuum at 150° C. for 1 hour to obtain 102 g of a modified hydrogenated petroleum resin A. Table 2 shows the analysis and evaluation results of the obtained modified hydrogenated petroleum resin A.

### Example 2-2

210 g of a modified hydrogenated petroleum resin B was obtained in the same manner as in Example 2-1 except that the amount of the hydrogenated petroleum resin E in Example 2-1 was set to 200 g, the amount of vinyltrimethoxysilane was set to 33 g, the amount of the organic peroxide (2,5-dimethyl-2,5-di(t-butylperoxy)hexane, trade name “PERHEXA (registered trademark) 25B”, manufactured by NOF Corporation) was set to 0.8 g, and the reaction time was set to 3 hours. Table 2 shows the analysis and evaluation results of the obtained modified hydrogenated petroleum resin B.

### Example 2-3

5 kg of the hydrogenated petroleum resin E obtained in Production Example 2-2, 500 g of vinyl trimethoxysilane (manufactured by Tokyo Chemical Industry Co., Ltd.), and 50 g of the organic peroxide (2,5-dimethyl-2,5-di(t-butylperoxy)hexane, trade name “PERHEXA (registered trademark) 25B”, manufactured by NOF Corporation) were mixed in advance at 20° C.

The obtained mixture was dropped onto the bottom of a hopper of a twin-screw extruder (TEM18SS, manufactured by Toshiba Machine Co., Ltd.) using a solenoid-driven diaphragm metering pump PW (manufactured by Takumina Co., Ltd.) at a rate of 174 g/hour, and the mixture was kneaded. The kneading conditions were a temperature of 200° C. and a residence time of about 70 seconds. The obtained kneaded product was taken out on a stainless steel tray and dried under vacuum at 150° C. for 1 hour to obtain 450 g of a modified hydrogenated petroleum resin C. Table 2 shows the analysis and evaluation results of the obtained modified hydrogenated petroleum resin C.

### Example 2-4

150 g of, as a hydrogenated petroleum resin, trade name “Escorez (registered trademark) 5300” (manufactured by ExxonMobile Chemical Company) was placed in a 500 mL separable flask equipped with a nitrogen introduction tube and a stirring blade, and heated to 160° C. in an oil bath under a nitrogen gas stream.

When the hydrogenated petroleum resin was dissolved, 6.8 g of vinyltrimethoxysilane (manufactured by Tokyo Chemical Industry Co., Ltd.) was added while stirring, and the mixture was stirred until homogeneous.

Then, 0.34 g of an organic peroxide (2,5-dimethyl-2,5-di(t-butylperoxy) hexane (trade name “PERHEXA (registered trademark) 25B”) were added dropwise. After the dropping, the mixture was stirred at an internal temperature (reaction mixture temperature) of 160° C. for 30 minutes and reacted.

Further, 30 minutes later, 0.34 g of “PERHEXA (registered trademark) 25B” was added, and 30 minutes later, 0.34 g of “PERHEXA (registered trademark) 25B” was further added and the mixture was reacted for 1 hour. After completion of the reaction, the mixture was dried at 150° C. for 1 hour while stirring under reduced pressure to obtain a modified hydrogenated petroleum resin F. Table 2 shows the analysis and evaluation results of the obtained modified hydrogenated petroleum resin F.

### Example 2-5

A modified hydrogenated petroleum resin G was obtained in the same manner as in Example 2-4 except that the hydrogenated petroleum resin used in Example 2-4 was changed from the trade name “Escorez (registered trademark) 5300” to trade name “Eastotac (registered trademark)C-100W” (manufactured by Eastman Company). Table 2 shows the analysis and evaluation results of the obtained modified hydrogenated petroleum resin G.

### Example 2-6

A modified hydrogenated petroleum resin H was obtained in the same manner as in Example 2-4 except that the hydrogenated petroleum resin used in Example 2-4 was changed from the trade name “Escorez (registered trademark) 5300” to the hydrogenated petroleum resin E obtained in the Production Example 2-2. Table 2 shows the analysis and evaluation results of the obtained modified hydrogenated petroleum resin H.

### Example 2-7

A modified hydrogenated petroleum resin I was obtained in the same manner as in Example 2-4 except that the hydrogenated petroleum resin used in Example 2-4 was changed from the trade name “Escorez (registered trademark) 5300” to trade name “Arkon (registered trademark) P-100” (manufactured by Arakawa Chemical Industries, Ltd.). Table 2 shows the analysis and evaluation results of the obtained modified hydrogenated petroleum resin I.

### Example 2-8

A modified hydrogenated petroleum resin J was obtained in the same manner as in Example 2-4 except that the hydrogenated petroleum resin used in Example 2-4 was changed from the trade name “Escorez (registered trademark) 5300” to trade name “I-MARV (registered trademark)S-100” (manufactured by Idemitsu Kosan Company, Ltd.). Table 2 shows the analysis and evaluation results of the obtained modified hydrogenated petroleum resin J.

### Example 2-9

The petroleum resin (110 g) obtained in Production Example 2-1 was put into a 500 mL separable flask equipped with a nitrogen introduction tube and a stirring blade, and heated in an oil bath (140° C.) under a nitrogen gas stream. Stirring was started when the mixture was melted, and after 12 g of vinyltrimethoxysilane (manufactured by Tokyo Chemical Industry Co., Ltd.) was added under a nitrogen gas stream, the mixture was stirred under a nitrogen atmosphere for 5 minutes. 0.5 g of the trade name “PERHEXA (registered trademark) 25B” was added dropwise in a nitrogen atmosphere. The oil bath temperature was raised to 150° C. (internal temperature of about 145° C.), and the mixture was stirred for 1 hour.

After completion of the reaction, the reaction product was taken out into a tray and dried at 150° C. under vacuum for 1 hour to obtain 98 g of a modified petroleum resin D. Table 3 shows the analysis and evaluation results of the obtained modified petroleum resin D.

### Comparative Example 2-1

As Comparative Example 2-1, the hydrogenated petroleum resin E obtained in Production Example 2-2 was analyzed and evaluated. The results are shown in Table 3.

### Comparative Example 2-2

As Comparative Example 2-2, the trade name “Escorez (registered trademark) 5300” (hereinafter, also referred to as “hydrogenated petroleum resin K”), which is the hydrogenated petroleum resin used in Example 2-4, was analyzed and evaluated. The results are shown in Table 3.

### Comparative Example 2-3

As Comparative Example 2-3, the trade name “Arkon (registered trademark) P-100” (hereinafter, also referred to as “hydrogenated petroleum resin L”), which is the hydrogenated petroleum resin used in Example 2-7, was analyzed and evaluated. The results are shown in Table 3.

TABLE 2

| | Ex. 2-1 | Ex. 2-2 | Ex. 2-3 | Ex. 2-4 | Ex. 2-5 | Ex. 2-6 | Ex. 2-7 | Ex. 2-8 |
|---|---|---|---|---|---|---|---|---|
| Petroleum resin | A | B | C | F | G | H | I | J |
| | Modified | Modified | Modified | Modified | Modified | Modified | Modified | Modified |
| | hydro- | hydro- | hydro- | hydro- | hydro- | hydro- | hydro- | hydro- |
| | genated | genated | genated | genated | genated | genated | genated | genated |
| Bromine value | 2.3 | 2.2 | 2.1 | 2.3 | 2.2 | 2.1 | 2.0 | 4.5 |
| (g/100 g) | | | | | | | | |
| Silicon element | 0.8 | 1.8 | 0.7 | 0.6 | 0.4 | 0.2 | 0.4 | 0.2 |
| concentration (%) | | | | | | | | |
| Weight average | 1120 | 1150 | 1700 | 790 | 1300 | 1100 | 1300 | 1200 |
| molecular | | | | | | | | |
| weight (Mw) | | | | | | | | |
| Molecular weight | 2.1 | 2.5 | 2.6 | 1.6 | 2.1 | 2.1 | 1.8 | 2.2 |
| distribution | | | | | | | | |
| (Mw/Mn) | | | | | | | | |
| Integral ratio of | 0.7 | 0.7 | 0.7 | 1.2 | 1.0 | 0.8 | 8.8 | 0.7 |
| aromatic | | | | | | | | |
| hydrogen (%) | | | | | | | | |
| Softening | 92.5 | 86.5 | 85.5 | 93.0 | 94.0 | 98.5 | 93.5 | 99.0 |
| point (° C.) | | | | | | | | |
| Volatile | 0.7 | 0.5 | 0.8 | 0.6 | 0.4 | 0.3 | 0.2 | 0.2 |
| component (%) | | | | | | | | |
| Odor | 1 | 1 | 1 | 1 | 1 | 1 | 1 | 1 |
| Colorlessness | 1 | 1 | 1 | 1 | 1 | 1 | 1 | 1 |
| (Gardner | | | | | | | | |
| color scale) | | | | | | | | |

TABLE 3

| | Ex. | Comp. Ex. | Comp. Ex. | Comp. Ex. |
|---|---|---|---|---|
| | 2-9 | 2-1 | 2-2 | 2-3 |
| Petroleum resin | D | E | K | L |
| | Modi- | Hydro- | Hydro- | Hydro- |
| | fied | genated | genated | genated |
| | | | (*1) | (*2) |
| Bromine value (g/100 g) | 58 | 2.1 | 1.2 | 0.8 |
| Silicon element | 0.1 | 0 | 0 | 0 |
| concentration (%) | | | | |
| Weight average molecular | 1100 | 1150 | 860 | 1300 |
| weight (Mw) | | | | |
| Molecular weight | 2.1 | 2.1 | 2.0 | 2.0 |
| distribution (Mw/Mn) | | | | |
| Integral ratio of aromatic | 30.0 | 0.7 | 1.2 | 1.0 |
| hydrogen (%) | | | | |
| Softening point (° C.) | 63.0 | 100.0 | 105.0 | 103.5 |
| Volatile component (%) | 0.6 | 0.7 | 0.3 | 0.2 |
| Odor | 3 | 1 | 1 | 1 |
| Colorlessness (Gardner | 16 | 1 | 1 | 1 |
| color scale) | | | | |

(*1): Trade name “Escorez 5300”
(*2): Trade name “Arkon P-100”

### [Production of Resin Composition (Adhesive)]

### Examples 2-10 to 2-17

The modified hydrogenated petroleum resins A to C and F to J obtained in Examples 2-1 to 2-8 were respectively melt-mixed with low crystalline polypropylene (trade name “L-MODU (registered trademark) S400”, manufactured by Idemitsu Kosan Co., Ltd.) so as to have the ratios (% by mass) shown in Table 4 at 180° C. to obtain each resin composition (adhesive). Table 4 shows the evaluation results of each of the obtained resin compositions.

### Reference Example 2-1

The modified petroleum resin D obtained in Example 2-9 was melt-mixed with low crystalline polypropylene (trade name “L-MODU (registered trademark) S400”, manufactured by Idemitsu Kosan Co., Ltd.) so as to have the ratio (% by mass) shown in Table 4 at 180° C. to obtain a resin composition (adhesive). Table 4 shows the evaluation result of the obtained resin composition.

### Comparative Example 2-4

The hydrogenated petroleum resin E obtained in Production Example 2-2 was melt-mixed with low crystalline polypropylene (trade name “L-MODU (registered trademark) S400”, manufactured by Idemitsu Kosan Co., Ltd.) so as to have the ratios (% by mass) shown in Table 4 at 180° C. to obtain a resin composition (adhesive). Table 4 shows the evaluation result of the obtained resin composition.

### Comparative Examples 2-5 to 2-6

The hydrogenated petroleum resins K and L used in Comparative Example 2-2 or 2-3 were respectively melt-mixed with low crystalline polypropylene (trade name “L-MODU (registered trademark) S400”, manufactured by Idemitsu Kosan Co., Ltd.) so as to have the ratios (% by mass) shown in Table 4 at 180° C. to obtain resin compositions (adhesives). Table 4 shows the evaluation results of the obtained resin compositions.

TABLE 4

| | | Ex. | Ex. | Ex. | Ex. | Ex. | Ex. | Ex. | Ex. | Ref. | Comp. | Comp. | Comp. |
|---|---|---|---|---|---|---|---|---|---|---|---|---|---|
| | | 2-10 | 2-11 | 2-12 | 2-13 | 2-14 | 2-15 | 2-16 | 2-17 | Ex. 2-1 | Ex. 2-4 | Ex. 2-5 | Ex. 2-6 |
| Modified | A | 30 | — | — | — | — | — | — | — | — | — | — | — |
| hydrogenated | B | — | 30 | — | — | — | — | — | — | — | — | — | — |
| petroleum | C | — | — | 30 | — | — | — | — | — | — | — | — | — |
| resin | F | — | — | — | 30 | — | — | — | — | — | — | — | — |
| | G | — | — | — | — | 30 | — | — | — | — | — | — | — |
| | H | — | — | — | — | — | 30 | — | — | — | — | — | — |
| | I | — | — | — | — | — | — | 30 | — | — | — | — | — |
| | J | — | — | — | — | — | — | — | 30 | — | — | — | — |
| Modified | D | — | — | — | — | — | — | — | — | 30 | — | — | — |
| petroleum | | | | | | | | | | | | | |
| resin | | | | | | | | | | | | | |
| Hydrogenated | E | — | — | — | — | — | — | — | — | — | 30 | — | — |
| petroleum | K | — | — | — | — | — | — | — | — | — | — | 30 | — |
| resin | L | — | — | — | — | — | — | — | — | — | — | — | 30 |
| Base polymer | S400 (*3) | 70 | 70 | 70 | 70 | 70 | 70 | 70 | 70 | 70 | 70 | 70 | 70 |
| Evaluation | Creep | 55 | 57 | 55 | 53 | 56 | 54 | 56 | 54 | 50 | 52 | 50 | 51 |
| | temperature | | | | | | | | | | | | |
| | (° C.) | | | | | | | | | | | | |

(*3) Trade name “L-MODU S400”

As is clear from the results in Table 2, the modified hydrogenated petroleum resins of the Examples have a faint odor and are excellent in colorlessness, and as is clear from the results in Table 4, the resin compositions containing the modified hydrogenated petroleum resins (adhesives) have excellent heat resistance.

### [Condensation Reaction Treatment of Modified Hydrogenated Petroleum Resin (A) (Production of Modified Hydrogenated Petroleum Resin (B))]

### Example 3-1

5 g of the modified hydrogenated petroleum resin A obtained in Example 2-1 was collected in a 20 mL sample bottle and heated in an oven at 180° C. for 3 minutes. Then, 0.04 g of dibutyltin dilaurate was put into the sample bottle taken out from the oven, mixed with the modified hydrogenated petroleum resin A, and by stirring the mixture with a spatula, the modified hydrogenated petroleum resin A was subjected to a condensation reaction due to the moisture in the air to obtain a modified petroleum hydrogenated petroleum resin AR. Table 5 shows the evaluation results of the obtained modified petroleum hydrogenated petroleum resin AR.

### Examples 3-2 to 3-8

Modified hydrogenated petroleum resins BR, CR, and FR to JR shown in the following Table 5 were obtained in the same manner as in Example 3-1 except that the modified hydrogenated petroleum resin A before the condensation reaction treatment in Example 3-1 was changed to the modified hydrogenated petroleum resins B, C and F to J obtained in Examples 2-2 to 2-8. Table 5 shows the evaluation results of the obtained modified hydrogenated petroleum resins BR, CR, and FR to JR.

### Example 3-9 and Comparative Examples 3-1 to 3-3

Each of petroleum resins DR, ER, KR and LR shown in the following Table 5 was obtained in the same manner as in Example 3-1 except that the modified hydrogenated petroleum resin A before the condensation reaction treatment in Example 3-1 was changed to the modified petroleum resin D obtained in Example 2-9, the hydrogenated petroleum resin E obtained in Production Example 2-2, the hydrogenated petroleum resins K and L used in Comparative Examples 2-2 and 2-3. Table 6 shows the evaluation results of each of the obtained petroleum resins DR, ER, KR and LR.

TABLE 5

| | | Ex. | Ex. | Ex. | Ex. | Ex. | Ex. | Ex. | Ex. |
|---|---|---|---|---|---|---|---|---|---|
| | | 3-1 | 3-2 | 3-3 | 3-4 | 3-5 | 3-6 | 3-7 | 3-8 |
| Petroleum resin | | AR | BR | CR | FR | GR | HR | IR | JR |
| (After condensation | | | | | | | | | |
| reaction treatment) | | | | | | | | | |
| Before | Resin | A | B | C | F | G | H | I | J |
| condensation | | Modified | Modified | Modified | Modified | Modified | Modified | Modified | Modified |
| reaction | | hydro- | hydro- | hydro- | hydro- | hydro- | hydro- | hydro- | hydro- |
| treatment | | genated | genated | genated | genated | genated | genated | genated | genated |
| | V0.1 | 110.2 | 105.4 | — | 98.5 | 93.6 | 95.4 | 105.6 | 186.3 |
| | V100 | 362.5 | 356.2 | — | 362.5 | 356.2 | 320.3 | 330.3 | 372.8 |
| | V0.1/V100 | 0.3 | 0.3 | — | 0.3 | 0.3 | 0.3 | 0.3 | 0.5 |
| After | V0.1 | 37808 | 17869 | 36205 | 12293 | 4250 | 4335 | 4526 | 4188 |
| condensation | | | | | | | | | |
| reaction | V100 | 376.7 | 356.4 | 332.3 | 342.5 | 375.9 | 324.8 | 385.5 | 365.2 |
| treatment | V0.1/V100 | 100.4 | 50.1 | 109.0 | 35.9 | 11.3 | 13.3 | 11.7 | 11.5 |

TABLE 6

| | | Ex. | Comp. Ex. | Comp. Ex. | Comp. Ex. |
|---|---|---|---|---|---|
| | | 3-9 | 3-1 | 3-2 | 3-3 |
| Petroleum resin | | DR | ER | KR | LR |
| (After condensation | | | | | |
| reaction treatment) | | | | | |
| Before | Resin | D | E | K | L |
| condensation | | Modi- | Hydro- | Hydro- | Hydro- |
| reaction | | fied | genated | genated | genated |
| treatment | | | | (*1) | (*2) |
| After | V0.1 | 143.2 | 100.2 | 280.3 | 93.6 |
| condensation | V100 | 373.8 | 359.5 | 342.5 | 363.4 |
| reaction | V0.1/V100 | 0.4 | 0.3 | 0.8 | 0.3 |
| treatment | | | | | |

(*1): Trade name “Escorez 5300”
(*2): Trade name “Arkon P-100”

As is clear from the results in Table 5, it was determined that, by being subjected to a condensation reaction treatment, the modified hydrogenated petroleum resins of Examples 3-1 to 3-8 had a low viscosity under a high shear rate and a high viscosity under a low shear rate.

On the other hand, as shown by the results in Table 6, it was determined that the hydrogenated petroleum resins of the Comparative Examples had a low viscosity at a low shear rate even after the condensation reaction treatment.

[Production of Adhesive Composition (C) Containing Modified Hydrogenated Petroleum Resin after Condensation Reaction Treatment]

### Example 3-10

In a 50 mL sample bottle, 4.0 g of low crystalline polypropylene (trade name “L-MODU (registered trademark) S400”, manufactured by Idemitsu Kosan Co., Ltd.), 5.0 g of the modified hydrogenated petroleum resin A obtained in Example 2-1, and 1.0 g of the trade name “Diana (trademark) process oil PW-90” (manufactured by Idemitsu Kosan Co., Ltd.) as a plasticizer were added, and the mixture was allowed to stand in an oven at 180° C. for 10 minutes and heated. Then, 0.04 g of dibutyltin dilaurate was put into the sample bottle taken out from the oven, and the mixture was stirred and mixed with a spatula. Thereafter, the mixture was again allowed to stand in an oven at 180° C. for 5 minutes and heated, taken out from the oven and then stirred and mixed with a spatula to obtain an adhesive composition. The evaluation results of the obtained adhesive composition are shown in Table 7.

When stirred and mixed with a spatula, a condensation reaction of the modified hydrogenated petroleum resin A is carried out due to the moisture in the air and the modified hydrogenated petroleum resin A is changing to the modified hydrogenated petroleum resin AR.

### Example 3-11

An adhesive composition was obtained in the same manner as in example 3-10 except that the modified hydrogenated petroleum resin A before the condensation reaction treatment to be blended in Example 3-10 was changed to the modified hydrogenated petroleum resin B obtained in Example 2-2. The evaluation results of the obtained adhesive composition are shown in Table 7.

When stirred and mixed with a spatula, a condensation reaction of the modified hydrogenated petroleum resin B is carried out due to the moisture in the air and the modified hydrogenated petroleum resin B is changing to the modified hydrogenated petroleum resin BR.

### Example 3-12

An adhesive composition was obtained in the same manner as in Example 3-11 except that the low crystalline polypropylene (trade name “L-MODU (registered trademark) S400”) in Example 3-11 was changed to an olefin-based elastomer (trade name “Affinity (registered trademark) GA1950”, manufactured by Dow). The evaluation results of the obtained adhesive composition are shown in Table 7.

### Comparative Example 3-4

An adhesive composition was obtained in the same manner as in Example 3-10 except that the modified hydrogenated petroleum resin A before the condensation reaction treatment to be blended in Example 3-10 was changed to the hydrogenated petroleum resin E obtained in Production Example 2-2. The evaluation results of the obtained adhesive composition are shown in Table 7.

When stirred and mixed with a spatula, a condensation reaction of the hydrogenated petroleum resin E is carried out due to the moisture in the air, and thus it is described as a hydrogenated petroleum resin ER in Table 7.

### Comparative Example 3-5

An adhesive composition was obtained in the same manner as in Comparative Example 3-4 except that the low crystalline polypropylene (trade name “L-MODU (registered trademark) S400”) in Comparative Example 3-4 was changed to an olefin-based elastomer (trade name “Affinity (registered trademark) GA1950”, manufactured by Dow). The evaluation results of the obtained adhesive composition are shown in Table 7.

TABLE 7

| | | Ex. | Ex. | Ex. | Comp. Ex. | Comp. Ex. |
|---|---|---|---|---|---|---|
| | | 3-10 | 3-11 | 3-12 | 3-4 | 3-5 |
| Modified | AR (*3) | 50 | — | — | — | — |
| hydrogenated | | | | | | |
| petroleum resin | BR (*4) | — | 50 | 50 | — | — |
| Hydrogenated | ER (*5) | — | — | — | 50 | 50 |
| petroleum resin | | | | | | |
| Base polymer | L-MODU S400 | 40 | 40 | — | 40 | — |
| | Affinity GA1950 | — | — | 40 | — | 40 |
| Plasticizer | PW-90 | 10 | 10 | 10 | 10 | 10 |
| Evaluation | V0.1 | 39800 | 612810 | 271390 | 2180.2 | 2102.7 |
| | V100 | 2208.2 | 3314.0 | 3100.6 | 1534.4 | 2193.3 |
| | V0.1/V100 | 18.0 | 184.9 | 87.5 | 1.4 | 1.0 |

(*3) blended as modified hydrogenated petroleum resin A, and subjected to condensation reaction treatment during heating and mixing.
(*4) blended as modified hydrogenated petroleum resin B, and subjected to condensation reaction treatment during heating and mixing.
(*5) blended as hydrogenated petroleum resin E, and subjected to condensation reaction treatment during heating and mixing.

As is clear from the results in Table 7, it was determined that, by mixing each component and then subjecting the modified hydrogenated petroleum resin A or B to a condensation reaction treatment, each adhesive composition of the Examples becomes an adhesive composition (the adhesive composition (C) described as the third invention) containing a modified hydrogenated petroleum resin after the condensation reaction treatment, has a low viscosity under a high shear rate and has a high viscosity under a low shear rate.

That is, since the adhesive composition has a low viscosity under a high shear rate, it has good coatability. Moreover, since the adhesive composition has a high viscosity under a low shear rate, it has improved cohesive force and improved adhesive strength.

On the other hand, as shown by the results in Table 7, it was determined that the adhesive compositions of the Comparative Examples had a low viscosity under a low shear rate even after the condensation reaction treatment was performed on the hydrogenated petroleum resin E.

### [Production and Evaluation of Asphalt Composition]

### Evaluation Examples 1 to 12 and Comparative Evaluation Examples 1 to 3

Among the silane compounds or modified hydrogenated petroleum resins obtained in the above Examples and Comparative Examples, those shown in Table 8 were used.

To 90.5 parts by mass of asphalt (straight asphalt) heated to 180° C., 4.0 parts by mass of an extract and 4.5 parts by mass of SBS were added, and the mixture was stirred at 3,000 rpm for 1.5 hours using a homomixer. Further, 1.0 part by mass of the silane-containing compound or the modified hydrogenated petroleum resin shown in Table 8 was added, and the mixture was stirred at 3,000 rpm for 30 minutes to obtain the asphalt composition shown in Table 8.

The asphalt used as a raw material has typical properties of a penetration of 67 ( 1/10 mm), a softening point of 48.0° C., and a density of 1,036 kg/m³ at 15° C. The extract is a petroleum-based solvent-extracted oil, and SBS has a molecular weight of about 150,000 (g/mol) and a styrene content of 30% by mass with respect to the entire SBS.

Further, in the Comparative Evaluation Examples, rosin (Comparative Evaluation Example 2) or a dimer acid (Comparative Evaluation Example 3) was used instead of the silane compound or the modified hydrogenated petroleum resin of the Evaluation Examples. In Comparative Evaluation Example 1, the silane compound or the modified hydrogenated petroleum resin of the Evaluation Examples was not blended, and 91.5 parts by mass, instead of 90.5 parts by mass, of asphalt was used. The rosin is a disproportionate gum rosin having an acid value of 156 (mgKOH/g: JIS K 0070) and a softening point of 77.0° C. (JIS K 2207), and the dimer acid is a tall oil fatty acid dimer having 36 carbon atoms and an acid value of 190 to 210 (mgKOH/g: JIS K 0070).

The water resistance (peeling resistance) was evaluated using the obtained asphalt composition. The evaluation results are shown in Table 8.

TABLE 8

| | | | Ev. | Ev. | Ev. | Ev. | Ev. | Ev. | Ev. | Ev. | Ev. | Ev. | Ev. | Ev. | Com. | Com. | Com. |
|---|---|---|---|---|---|---|---|---|---|---|---|---|---|---|---|---|---|
| | | | Ex. | Ex. | Ex. | Ex. | Ex. | Ex. | Ex. | Ex. | Ex. | Ex. | Ex. | Ex. | Ev. | Ev. | Ev. |
| | | | 1 | 2 | 3 | 4 | 5 | 6 | 7 | 8 | 9 | 10 | 11 | 12 | Ex. 1 | Ex. 2 | Ex. 3 |
| Blending | Asphalt | Asphalt | 90.5 | 90.5 | 90.5 | 90.5 | 90.5 | 90.5 | 90.5 | 90.5 | 90.5 | 90.5 | 90.5 | 90.5 | 91.5 | 90.5 | 90.5 |
| ratio | base oil | Extract | 4.0 | 4.0 | 4.0 | 4.0 | 4.0 | 4.0 | 4.0 | 4.0 | 4.0 | 4.0 | 4.0 | 4.0 | 4.0 | 4.0 | 4.0 |

| | | | | | | | | | | | | | | | | |
|---|---|---|---|---|---|---|---|---|---|---|---|---|---|---|---|---|
| (mass %) | SBS | 4.5 | 4.5 | 4.5 | 4.5 | 4.5 | 4.5 | 4.5 | 4.5 | 4.5 | 4.5 | 4.5 | 4.5 | 4.5 | 4.5 | 4.5 |
| Silane | Rosin | — | — | — | — | — | — | — | — | — | — | — | — | — | 1.0 | — |
| compound, | Dimer acid | — | — | — | — | — | — | — | — | — | — | — | — | — | — | 1.0 |
| modified | A | 1.0 | — | — | — | — | — | — | — | — | — | — | — | — | — | — |
| hydrogenated | B | — | 1.0 | — | — | — | — | — | — | — | — | — | — | — | — | — |
| petroleum | C | — | — | 1.0 | — | — | — | — | — | — | — | — | — | — | — | — |
| resin | F | — | — | — | 1.0 | — | — | — | — | — | — | — | — | — | — | — |
| etc. | G | — | — | — | — | 1.0 | — | — | — | — | — | — | — | — | — | — |
| Blending | H | — | — | — | — | — | 1.0 | — | — | — | — | — | — | — | — | — |
| ratio | I | — | — | — | — | — | — | 1.0 | — | — | — | — | — | — | — | — |
| (mass %) | J | — | — | — | — | — | — | — | 1.0 | — | — | — | — | — | — | — |
| | P | — | — | — | — | — | — | — | — | 1.0 | — | — | — | — | — | — |
| | Q | — | — | — | — | — | — | — | — | — | 1.0 | — | — | — | — | — |
| | S | — | — | — | — | — | — | — | — | — | — | 1.0 | — | — | — | — |
| | T | — | — | — | — | — | — | — | — | — | — | — | 1.0 | — | — | — |
| Evaluation | Average peeling | 0 | 0 | 10 | 10 | 15 | 20 | 15 | 20 | 0 | 0 | 0 | 0 | 90 | 87.5 | 55 |
| | rate of upper | | | | | | | | | | | | | | | |
| | and lower | | | | | | | | | | | | | | | |
| | surfaces (%) | | | | | | | | | | | | | | | |
| | Result | A | A | A | A | A | A | A | A | A | A | A | A | B | B | B |

From the results in Table 8, it can be seen that the silane-containing compound according to the first invention can suppress the peeling of asphalt and improve the water resistance. Further, it can be seen that the modified hydrogenated petroleum resin according to the second invention can also suppress the peeling of asphalt and improve the water resistance.

1. An asphalt composition comprising the silane-containing compound comprising a cyclic structure in a molecular structure and straight asphalt, wherein the straight asphalt has a content of 70.00 to 99.99% by mass.

2. The asphalt composition according to claim 1, wherein the cyclic structure in the silane-containing compound is a structure in which three or more of at least one ring structure selected from an aromatic ring and a 5- or more membered alicyclic ring are linked.

3. The asphalt composition according to claim 1, wherein the cyclic structure in the silane-containing compound is a structure represented by any of the following general formulae (1) to (4): 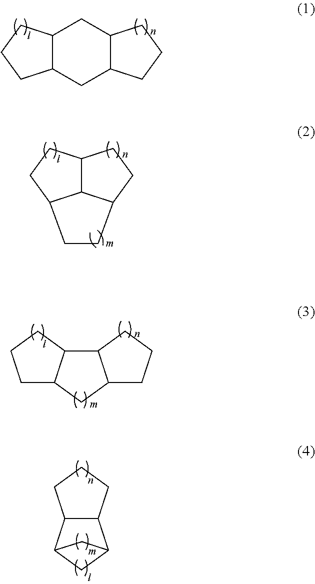
wherein
l, m and n each are independently 1 or 2, and a straight line indicates a single bond or a double bond, provided that the double bond is not continuous.

4. The asphalt composition according to claim 1, wherein the cyclic structure in the silane-containing compound is a structure represented by any of the following formulae (5) to (7):

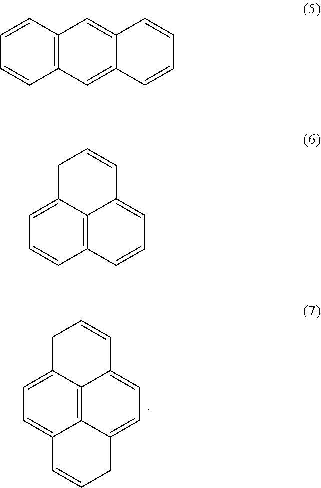

5. The asphalt composition according to claim 1, wherein the cyclic structure in the silane-containing compound is a structure represented by any of the following formulae (8) to (11):

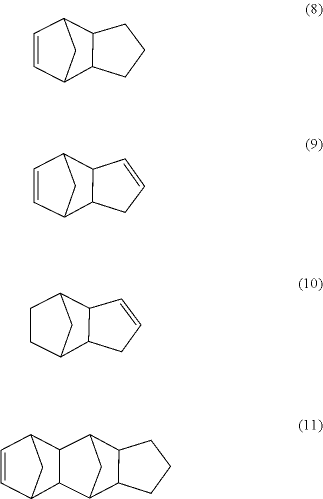

6. The asphalt composition according to claim 1, wherein an integral ratio of aromatic hydrogen [integral value of peak in 6.5 to 7.5 ppm region/(sum of integral value of peak in 0 to 3.0 ppm region and integral value of peak in 6.5 to 7.5 ppm region)] in ¹H-NMR measurement in the silane-containing compound is 70% or less.

7. The asphalt composition according to claim 1, wherein the silane-containing compound has a softening point of 90° C. or higher.

8. The asphalt composition according to claim 1, wherein the silane-containing compound has a viscosity at 40° C. of 1 to 1,000 mPa·s.

9. The asphalt composition according to claim 1, wherein the silane-containing compound has a glass transition temperature of 30° C. or higher.

10. The asphalt composition according to claim 1, wherein a ratio of absorbance (ASiO) derived from a silicon-oxygen bond and absorbance (ACH) derived from a carbon-hydrogen bond in IR measurement in the silane-containing compound satisfies the following relational expression:
$$0.01 < ASiO / ACH < 0.37 .$$

11. The asphalt composition according to claim 1, wherein an integral ratio of tertiary carbon [integral value of peak in 35 to 64 ppm region/integral value of peak in 10 to 64 ppm region] in 13C-NMR measurement in the silane-containing compound is 2 to 80%.

12. An asphalt mixture, comprising:
the asphalt composition according to claim 1; and
an aggregate,
wherein the aggregate has a content of 80 to 99% by mass.
